(19) United States
(12) Patent Application Publication
(10) Pub. No.: US 2008/0051033 A1
(43) Pub. Date: Feb. 28, 2008

(54) WIRELESS COMMUNICATIONS WITH VISUALLY- IDENTIFIED TARGETS

(76) Inventor: Charles Martin Hymes, Eugene, OR (US)

Correspondence Address: Charles Hymes, 1450 E. 23rd Avenue, Eugene, OR, 97403, US

(21) Appl. No.: 11/467,902

(22) Filed: Aug. 28, 2006

(51) Int. Cl. H04B 1/68

(52) U.S. Cl. 455/47

(57) ABSTRACT

A mechanism for initiating contact with someone, via a telecommunications system, who is in the admirer's proximity, but whose identity or telecommunications address (e.g., telephone number, e-mail address, etc.) is unknown. The illustrative embodiments enable the user to use what information he does know about the admired person—the admiring person's distinguishing characteristics—to get a telecommunications address through which the initial contact can be made.

### FIELD OF THE INVENTION

The present invention relates to telecommunications in general, and, more particularly, to mobile social telecommunications.

### BACKGROUND OF THE INVENTION

All potentially compatible people can be separated into two categories. The first category consists of all the people that one is not aware of because one has not met them, seen them, or even heard of them. This is the group addressed by online dating services, newspaper personal ads, and match makers in that they alert the individual to the existence of specific other individuals who may be compatible.

Newer technological developments that serve this same population are hand-held devices such as the Japanese Lovegety and the Spotme device that alert the user to potentially compatible people in the user's immediate environment that would have otherwise gone unnoticed. Even more recently a cellular telephone company, AT&T Wireless, in conjunction with an online dating service, Match.com, has offered a profile matching service to cellular telephone users that is activated when users are in the same physical proximity. All of these services alert the user to potentially compatible partners that the user otherwise would not know about.

The second category of people consists of all the people that one does in fact already know about because one has already met them, heard of them, or at least seen them. This group includes friends, classmates, colleagues, acquaintances, and the largest group—strangers that one becomes aware of in the normal course of everyday activity in a grocery store, elevator, subway train, restaurant, etc.

When it comes to having a relationship with someone among this second category, one is usually aware of which individuals one is interested in and which individuals one is not interested in. In this case, the issue then is not who to date, but rather how to go about making that happen. There is, therefore, a need to facilitate developing relationships with the people that one is already interested in.

### SUMMARY OF THE INVENTION

The present invention facilitates the introduction to people with whom one is aware, without some of the costs and disadvantages of techniques for doing so in the prior art. To this end, the illustrative embodiment of the present invention addresses the four main obstacles that hinder people—admirers—from approaching others that they are attracted to—admired persons. The three obstacles are:

Invasiveness—If the admired person is a stranger, it may be awkward to approach him or her because the social circumstance may not be appropriate, conducive, or convenient to physically approach the person. For example, the admired person may be talking on the telephone, or talking to a group of friends. Some embodiments of the present invention address the invasiveness obstacle by providing a non-invasive mechanism for communication (e.g., text messaging, e-mail, etc.) between the admirer and the admired person.

Fear of Rejection—The fear of rejection hinders many admirers from approaching admired persons. If the admired person and the admirer already have a non-romantic relationship, such as that of co-workers, then the consequences of rejection can be quite significant. Some embodiments of the present invention address the fear of rejection obstacle by using additional entities (e.g., a data processing system, the admirer's and admired party's telecommunications terminals, etc.) to confide their interest in such that only when both persons express an interest in the other do the entities reveal to both of them their mutual attraction.

Fear of Embarrassment of Rejection—The fear of being embarrassed in front of one's friends hinders many admirers from approaching admired persons. Some embodiments of the present invention address the fear of embarrassment of rejection by enabling the admirer to initiate contact with the admired person via his or her telecommunications terminal, which is less conspicuous than approaching the admired person in front of one's friends.

To accomplish these goals, the illustrative embodiments provide a mechanism for initiating contact with someone, via a telecommunications system, who is in the admirer's proximity, but whose telecommunications address (e.g., telephone number, e-mail address, etc.) is unknown. The illustrative embodiments enable the user to use what information he does know about the admired person—the admired person's distinguishing characteristics—to determine a telecommunications address through which the initial contact can be made.

The first illustrative embodiment comprises: determining an address in the address space of a telecommunications network based on an image of a person; and directing a telecommunications terminal to reveal to a user of the telecommunications terminal at least a portion of a first message that is received from the address in particular, wherein the prior treatment for a message from the address and addressed to the user is to hide at least the portion of the message from the user.

### BRIEF DESCRIPTION OF THE DRAWINGS

FIG. 1 depicts a diagram of an environment in which the first illustrative embodiment of the present invention operates.

FIG. 2 depicts a block diagram of the salient components of wireless terminal 101-i, for i=1 through 8.

FIG. 3 depicts a flowchart of the salient tasks performed by a person's wireless terminal, in accordance with the first illustrative embodiment, to enable that person to be an admirer.

FIG. 4 depicts a flowchart of the salient tasks associated with task 302 in FIG. 3.

FIG. 5 depicts a flowchart of the salient tasks performed by a person's wireless terminal, in accordance with the first illustrative embodiment, to enable that person to be an admired person.

FIG. 6 depicts a diagram of an environment in which the second illustrative embodiment of the present invention operates.

FIG. 7 depicts a block diagram of the salient components of wireless terminal 601-i, for i=1 through 8.

FIG. 8 depicts a flowchart of the salient tasks performed by a data processing system, in accordance with the second illustrative embodiment, to enable a person to be an admirer.

FIG. 9 depicts a flowchart of the salient tasks performed by a data processing system, in accordance with the second illustrative embodiment, to enable a person to be an admired person.

### DETAILED DESCRIPTION

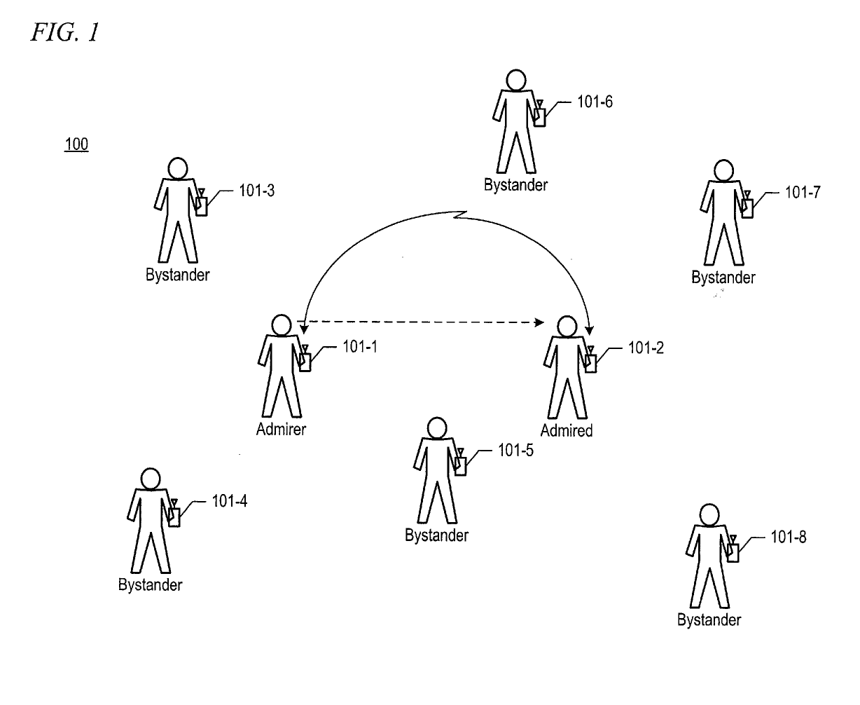

FIG. 1 depicts a diagram of an environment in which the first illustrative embodiment of the present invention operates. Environment 100 is a gathering of eight people within recognition proximity of each other. The fact that the people are within recognition proximity of each other is a salient characteristic of the first illustrative embodiment because the embodiment facilitates the introduction of people who are in actual physical proximity to one another and can see each other.

One of the people in the gathering, the “First Person,” sees another person, the “Second Person,” and desires to initiate communications with him or her. The other people who are present at the gathering are merely bystanders.

In accordance with the first illustrative embodiment, each person carries a telecommunications terminal that facilitates the introduction of him or her to another person.

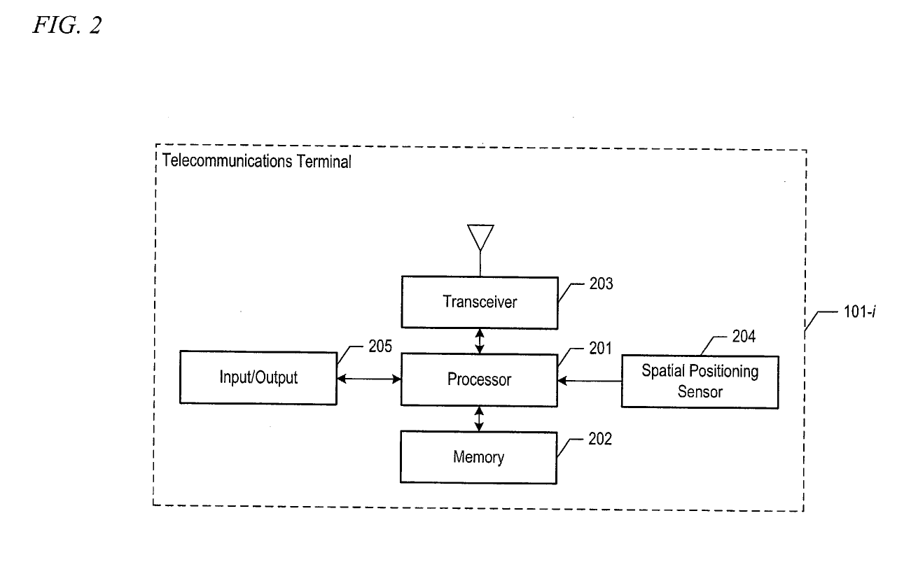

FIG. 2 depicts a block diagram of the salient components of wireless terminal 101-i, for i=1 through 8. In accordance with the first illustrative embodiment, wireless terminal 101-i is distinguishable and addressable by an address in the address space of the telecommunications system in which it functions. This is important because each user's terminal's address serves as an identifier for the user such that:
i. a message addressed to the address of a user's wireless terminal can be considered a message to the user, and
ii. a message from the address can be considered a message from the user.

Wireless terminal 101-i comprises processor 201, memory 202, transceiver 203, spatial positioning sensor 204, and input/output 205.

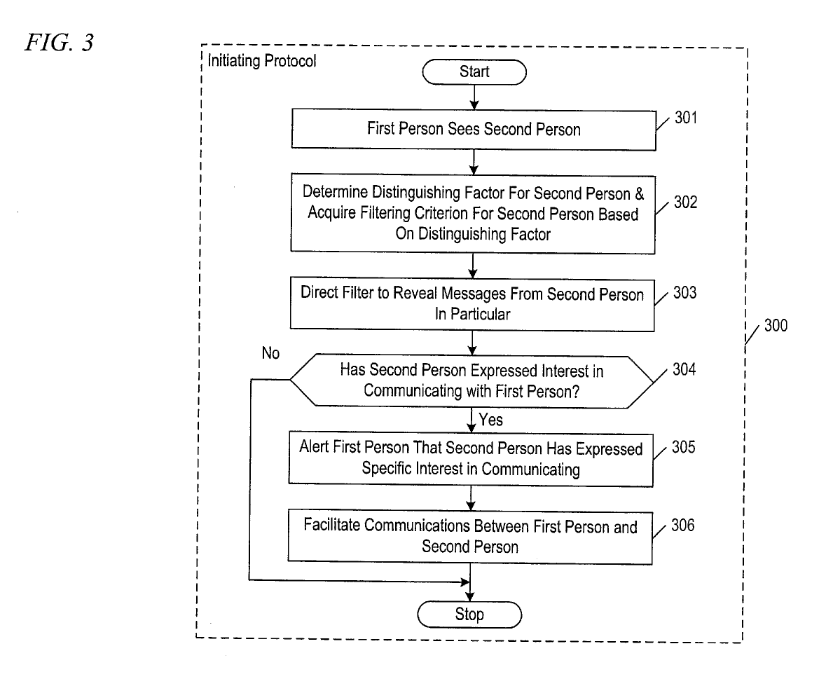

Processor 201 is a general-purpose processor, in well-known fashion, that is capable of interacting with memory 202, transceiver 203, and spatial positioning sensor 204 in well-known fashion, and that is additionally capable of performing the functionality described below and with respect to FIGS. 3 through 5.

Memory 202 is a non-volatile random-access memory, in well-known fashion, that stores the operating system and application software for processor 201. In accordance with the first illustrative embodiment, memory 202 also stores an image (e.g., a picture, etc.) of the user associated with the terminal.

Transceiver 203 is a bidirectional radio transceiver, in well-known fashion, that enables wireless terminal 101-i to communicate voice, text, and video with the other wireless terminals directly (e.g., through a Bluetooth network, etc.), through a base station (e.g., a WiFi access point, etc.) (not shown in FIG. 1), and with remote data processing systems that are accessible via a base station access point, etc.

Spatial positioning sensor 204 is a sensor (e.g., a Global Positioning System receiver, etc.), in well-known fashion, that is capable of ascertaining the spatial position (e.g., the latitude and longitude, etc.) of wireless terminal 101-i.

Input/output 205 comprises a keypad, display, camera, and acoustic transducers, in well-known fashion, which enable a user to communicate via voice, text, and video.

It will be clear to those skilled in the art, after reading this disclosure, how to make and use alternative embodiments of the present invention in which one or both of the First Person's terminal and the Second Person's terminal are wireline terminals. Furthermore, it will be clear to those skilled in the art, after reading this disclosure, how to make and use alternative embodiments of the present invention that are part of a different system (e.g., a wireless local area network, the Internet, a Bluetooth network, etc.) and, therefore, are distinguishable and addressable by an address (e.g., an IPV6 address, a MAC address, etc.) in a different address space. And still furthermore, it will be clear to those skilled in the art how to make and use alternative embodiments of the present invention for purposes other than dating and romance (e.g., to facilitate business dealings, etc.).

In accordance with the first illustrative embodiment, the First Person's terminal communicates at the physical layer directly with the Second Person's terminal without the assistance of a base station or intermediary. Furthermore, in accordance with the first illustrative embodiment, the First Person's terminal communicates at the application layer directly with the Second Person's terminal without the assistance of a third-party data processing system. In contrast, the second illustrative embodiment of the present invention, which is described in detail below, operates in conjunction with a data processing system.

In accordance with the first illustrative embodiment, each person's terminal continually runs software that enables the person to be both:
i. an admirer (i.e., initiate contact with an admired person), and
ii. an admired person (i.e., receive an anonymous message from an admirer).

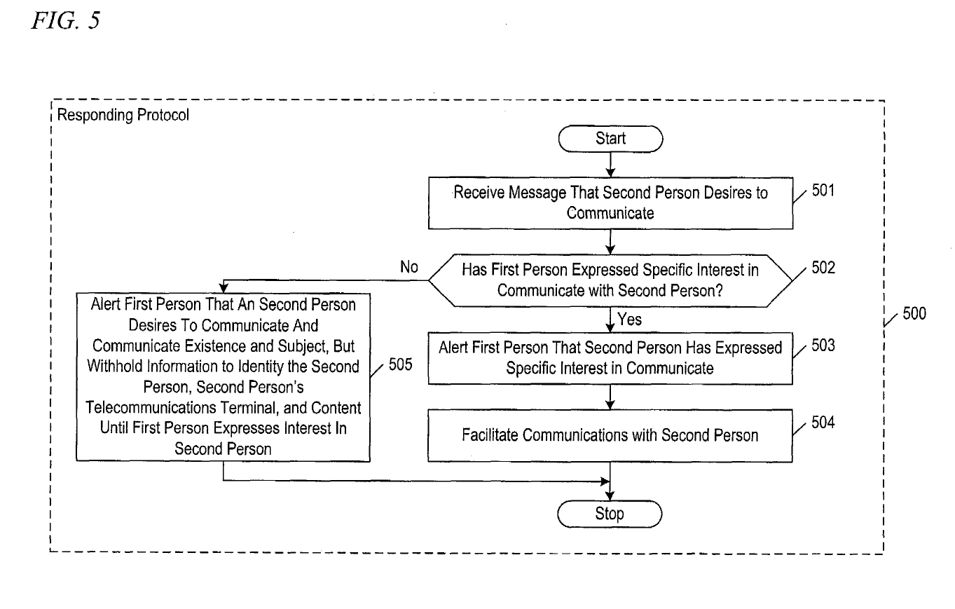

### The functionality depicted in FIG. 3 enables a person, via his or her terminal, to be an admirer, and the functionality depicted in FIG. 5 enables a person, via his or her terminal, to be an admired person.

With respect to task 301 in FIG. 3, the First Person sees the Second Person.

At task 302, the First Person's terminal (i) determines one or more distinguishing factors for the Second Person, and (ii) acquires a filtering criterion based the distinguishing factors.

For the purposes of this disclosure, a “distinguishing factor” is defined as information that distinguishes the Second Person from at least one other person. For example, the distinguishing factor includes, but is not limited to:
i. an indication of a physical trait of the Second Person (e.g., an image, a voiceprint, an iris scan, the person's genome, a fingerprint, a physical description, etc.), or
ii. an indication of the spatial position of the Second Person (e.g., the latitude and longitude of the Second Person, etc.), or
iii. an indication of the identity of the Second Person (e.g., a name, a social security number, a street address, etc.), or
iv. an address of the Second Person in the address space of a telecommunications network (e.g., a telephone number, a computer screen name, an e-mail address, etc.), or
v. any combination of i, ii, iii, and iv.

For the purpose of this disclosure, a “filtering criterion∞ is defined as information that distinguishes a telecommunications message from the Second Person from a telecommunications message from at least one other person. For example, the filtering criterion includes, but is not limited to:
i. an address in the address space of a telecommunications network, or
ii. an indication of the identity of a person, and
iii. a combination of i and ii.

### In accordance with the first illustrative embodiment, the distinguishing factor is an image of the user's face (i.e., a portrait of the user), and the filtering criterion is the telephone number of the terminal.

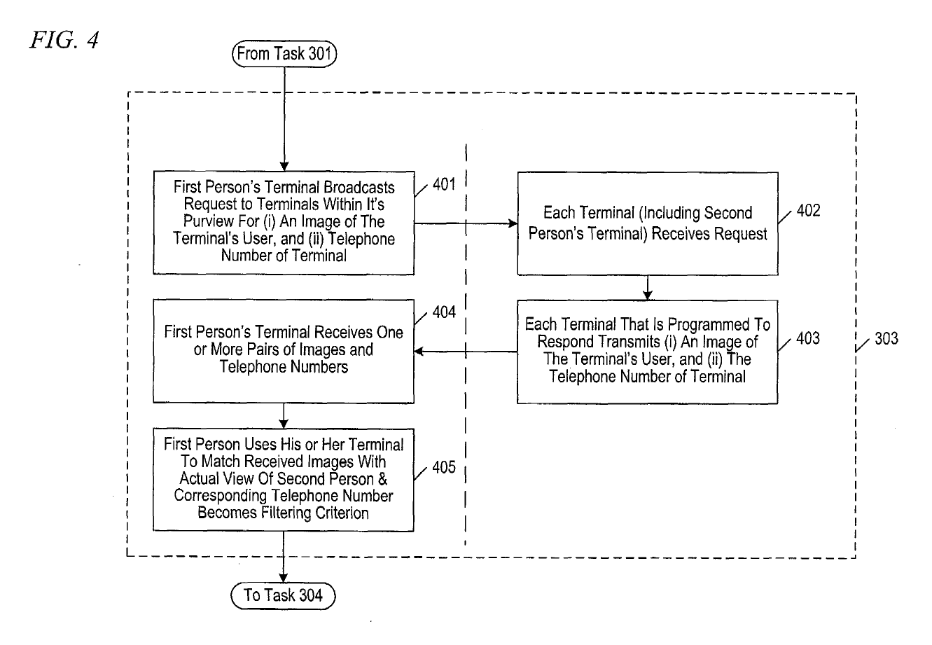

FIG. 4 depicts a flowchart of the salient subtasks associated with the performance of task 302 in accordance with the first illustrative embodiment

At task 401, the First Person's terminal broadcasts a request to all of the other terminals for (i) one or more distinguishing factors, and (ii) one or more filtering criterion for that user. In accordance with the first illustrative embodiment, the First Person's terminal requests an image of the terminal's user as the distinguishing factor and the telephone number of the terminal as the filtering criterion.

At task 402, all of the other terminals within the purview of the First Person's terminal, including the Second Person's terminal, receive the request transmitted in task 401.

At task 403, all of the terminals that are programmed to respond to the request, including the Second Person's terminal, do so.

At task 404, the First Person's terminal receives a distinguishing factor-filtering criterion pair from each of the responding terminals.

At task 405, the First Person compares the images he or she has received with his or her actual view of the Second Person and indicates to his or her terminal which of the images corresponds to the Second Person. The terminal then selects the telephone number (that was received with that image) as the filtering criterion for use in tasks 303 through 306.

Because the First Person's terminal was given the image-address pairs, the task of acquiring the filtering criterion based on the distinguishing characteristic is simple. But as alluded to previously and as described below and in conjunction with the second illustrative embodiment, the task of acquiring the filtering criterion based on the distinguishing characteristic can be more complex. For example, it will be clear to those skilled in the art however, after reading this disclosure, how to make and use alternative embodiments of the present invention in which the First Person's terminal generates the distinguishing factor itself (e.g., with a camera to take the Second Person's picture, etc.) or receives it from another entity (e.g., a remote data processing system, etc.). One example of this is described below and in conjunction with the second illustrative embodiment.

As part of task 302, the First Person compares, with his or her terminal, the images in the responses to the physical traits of the Second Person. When the First Person has determined which of the images corresponds to the Second Person, the First Person indicates that determination to the terminal. In accordance with the first illustrative embodiment the First Person's terminal is simply given the filtering criterion by the Second Person's terminal, and the association between the filtering criterion and the distinguishing factor. It will be clear to those skilled in the art however, after reading this disclosure, how to make and use alternative embodiments of the present invention in which the First Person's terminal uses the distinguishing factor to determine (e.g., through a pattern matching process, through a lookup process, etc.) the filtering criterion. This can, for example, involve the use of local or remote databases and can also, for example, involve the cooperation of remote data processing systems. One example of this is described below and in conjunction with the second illustrative embodiment.

At task 303, the First Person indicates to his or her terminal his or her interest in communicating with the Second Person and does this by directing the terminal to reveal to him or her the existence and complete content of any messages that have been sent, or might be sent, from the Second Person (as identified by his or her filtering criterion). In accordance with the first illustrative embodiment, the First Person expresses either:
(1) an active interest to communicate with the Second Person, or
(2) a passive interest to communicate with the Second Person.

When the First Person expresses an active interest in communicating with the Second Person, the First Person's terminal sends a message to the Second Person using the filtering criterion determined in task 302. The message comprises:
i. an indication of the identity of the First Person (e.g., the identity of the First Person, an image of the First Person, etc.), and
ii. the First Person's filtering criterion (e.g., Bluetooth network address, etc.),
iii. a subject (e.g., “Message From An Admirer,” etc.), and
iv. content (e.g., “Can I buy you a drink?” etc.).

When, in contrast, the First Person expresses a passive interest to communicate with the Second Person, the First Person does not send a message to the Second Person but informs his or her terminal that he or she is willing to communicate with the Second Person if it receives a message from the Second Person.

As described below and with respect to FIG. 5, the advantage of passive interest is that the Second Person is less likely to discover that the First Person has expressed and interest in him or her in the case that the Second Person does not express and interest in the First Person. The disadvantage with passive interest is that if both the First Person and the Second Person indicate passive interest with respect to each other, a deadlock arises and nothing materializes even though both persons are interested in each other.

In contrast, the advantage of active interest is that it alerts the Second Person that he or she has a suitor, and, therefore, might prompt the Second Person to express an interest (either active or passive) in communicating with the First Person when he or she might otherwise not. The disadvantage of active interest is that there is an increased risk that the Second Person may be able to subvert this process and gain access to hidden portions of a message received from the First Person without expressing interest in the First Person. This increased risk exists because the entirety of the message sent to the Second Person actually resides on the Second Person's device.

In either case, as part of task 303, the telephone number of the Second Person is stored in a List of Admired Persons that is permanently stored in the First Person's terminal. An example of such a list is depicted in Table 1. As described below and with respect to FIG. 5, this list is used by the terminal when messages arrive for the First Person to enable the terminal to discern which messages are from acceptable Second Persons and which are not.

TABLE 1
List of Admired Persons
Telephone Number
(filtering criterion)
201-555-2343
323-443-5523
345-646-3342
532-343-6681

At task 304, the First Person's terminal determines if the Second Person has previously expressed an interest in communicating with the First Person. This is necessary because the First Person's terminal might have previously received a message from the Second Person and which message was partially or wholly hidden from the First Person. This situation is likely because the First Person might be performing this series of tasks in response to the receipt of a message from the Second Person. In either case, the Second Person's telephone number is searched for in a List of Admirers (i.e., those people who have sent the First Person a message that was partially or wholly hidden from the First Person) that is permanently stored in the First Person's terminal. An example of such a list is depicted in Table 2.

TABLE 2
List of Admirers
Telephone Number
574-587-2541
965-852-3854
532-343-6681
201-587-6936
568-985-9699
542-875-8785

### How and when Table 2 is populated is described below and with respect to FIG. 5. When the Second Person's telephone number is within the List of Admirers, control passes to task 306; otherwise control stops.

At task 305, the First Person's terminal alerts the First Person to the fact that the Second Person has previously sent the First Person a message, and, therefore, has previously expressed an interest to communicate. As part of task 305, the First Person's terminal reveals to the First Person the entire message that was received from the Second Person.

At task 306, the First Person's terminal initiates a voice call with the Second Person's terminal so that the First Person and the Second Person can freely communicate. It will be clear to those skilled in the art, after reading this disclosure, how to make and use alternative embodiments of the present invention in which the communication in task 306 is through text, voice, or video.

FIG. 5 depicts a flowchart of the salient tasks associated with the First Person and his or her terminal when the First Person receives a message of admiration transmitted from a Third Person, who might or might not be the Second Person.

At task 501, the First Person's terminal receives a message transmitted from a Third Person. The message comprises:
i. an indication of the identity of the Third Person,
ii. the Third Person's terminal's telephone number,
iii. a subject, and
iv. content.

At task 502, the First Person's terminal determines if the First Person has ever expressed an interest (either active or passive) in communicating with the Third Person. Task 502 is accomplished by searching for the Third Person's telephone number in the First Person's List of Admired Persons. If the Third Person's telephone number is in the List of Admired Persons, then control passes to task 503; otherwise control passes to task 505.

At task 503, the First Person's terminal alerts the First Person to the arrival of the message and provides the user with the message.

At task 504, the First Person's terminal initiates a voice call with the Third Person's terminal so that the First Person and the Third Person can freely communicate. It will be clear to those skilled in the art, after reading this disclosure, how to make and use alternative embodiments of the present invention in which the communication in task 504 is through text, voice, or video.

At task 505, the First Person's terminal alerts the First Person to the arrival of the message, and provides the First Person with:
i. the subject of the message,
   but withholds:
i. information that identifies the Third Person, and
ii. the Third Person's terminal's telephone number, and
iii. the content of the message.
   Upon the receipt of the message from the Third Person, the First Person might be prompted to look around and consider sending a message to someone he or she admirers. If that happens to be the Third Person, then a connection is made. If not, the Fourth Person might be prompted to look around and consider sending a message to someone he or she admirers. In some alternative embodiments of the present invention, all of the message and also its existence is withheld from the admired person until the admired person expresses an interest in communicating with the admirer.

As part of task 505, the First Person's terminal adds the Third Person's terminal's telephone number to its List of Admirers, as depicted in Table 2. After task 505, control stops.

The first illustrative embodiment illustrates just one way in which the various telecommunications terminals can operate independently and without the assistance of a remote data processing system. Although there are advantages to this, there are disadvantages as well, and, therefore, the second illustrative embodiment illustrates one way in which the various telecommunications terminals can operate in conjunction with a data processing system.

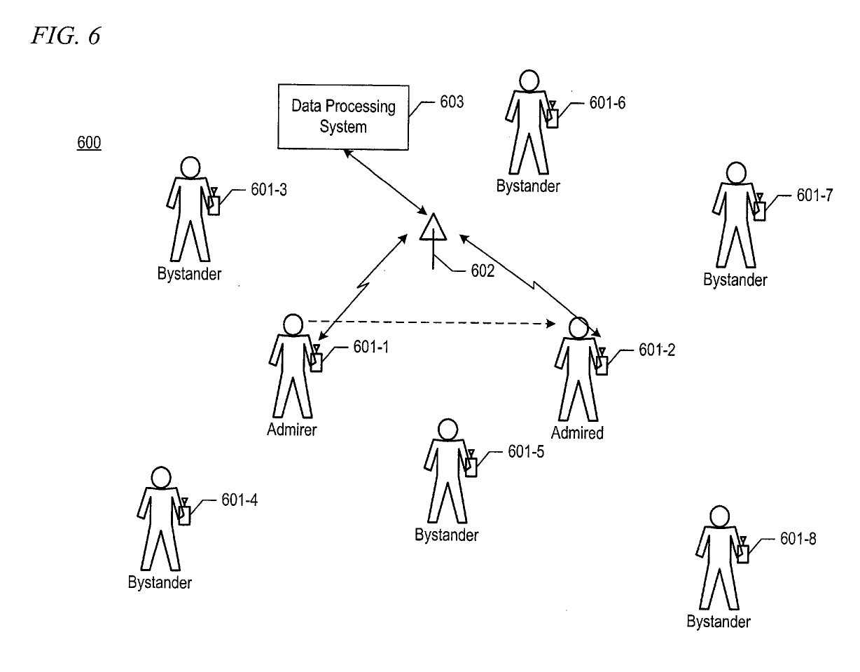

FIG. 6 depicts a diagram of an environment in which the second illustrative embodiment of the present invention operates. Environment 600, like environment 100 in FIG. 1, is a gathering of eight people within recognition proximity of each other. The fact that the people are within recognition proximity of each other is a salient characteristic of the second illustrative embodiment because it, like the first illustrative embodiment, facilitates the introduction of people who are in actual physical proximity to one another and can see each other.

One of the people in the gathering, the “First Person,” sees another person, the “Second Person,” and desires to initiate communications with the him or her. The other people who are present at the gathering are merely bystanders.

In accordance with the second illustrative embodiment, each person carries a telecommunications terminal that facilitates the introduction of him or her to another person.

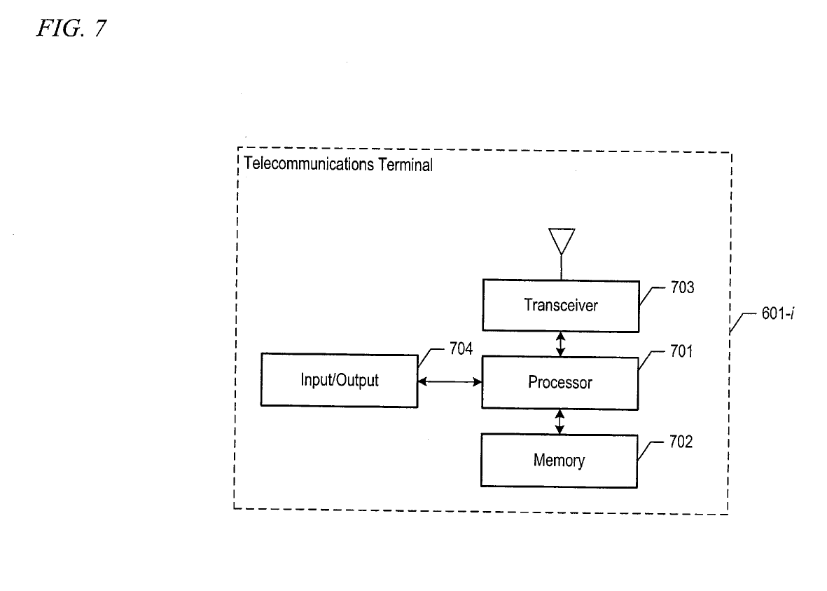

FIG. 7 depicts a block diagram of the salient components of wireless terminal 601-i, for i=1 through 8. In accordance with the second illustrative embodiment, wireless terminal 601-i is distinguishable and addressable by an address in the address space of the telecommunications system in which it functions. This is important because each user's terminal's address serves as an identifier for the user such that:
i. a message addressed to the address of a user's wireless terminal can be considered a message to the user, and
ii. a message from the address can be considered a message from the user.

Wireless terminal 601-i comprises processor 701, memory 702, transceiver 703, and input/output 705.

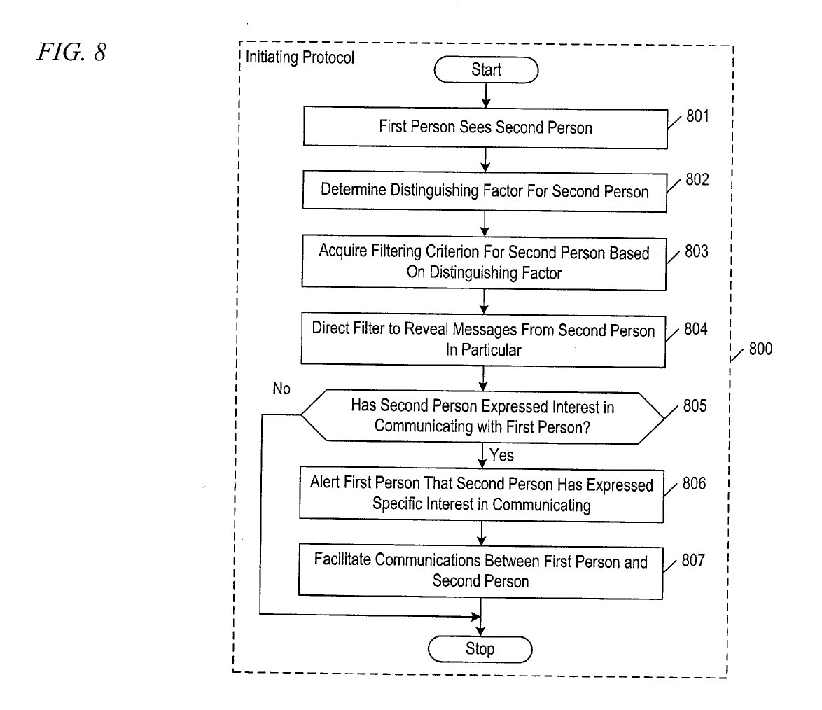

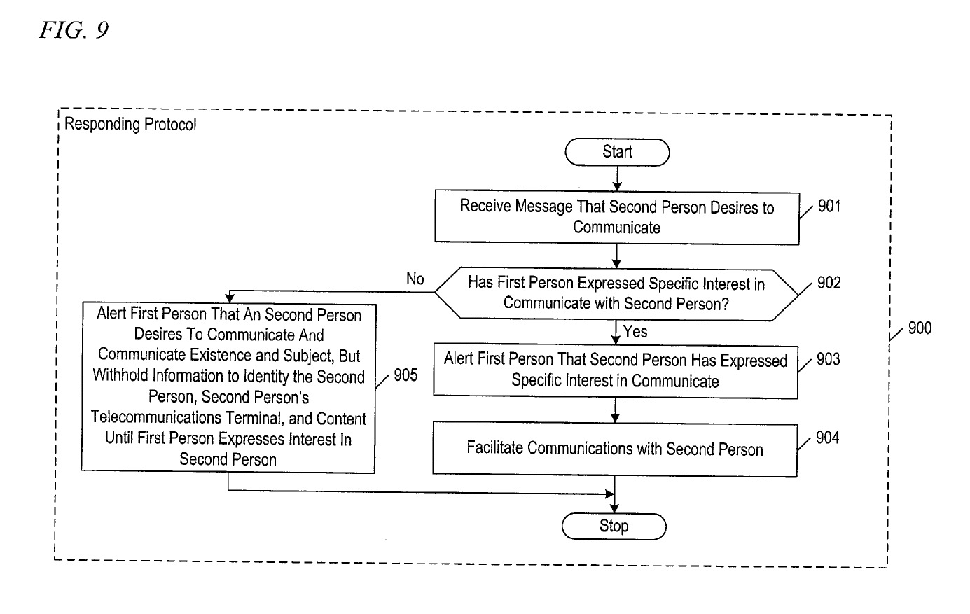

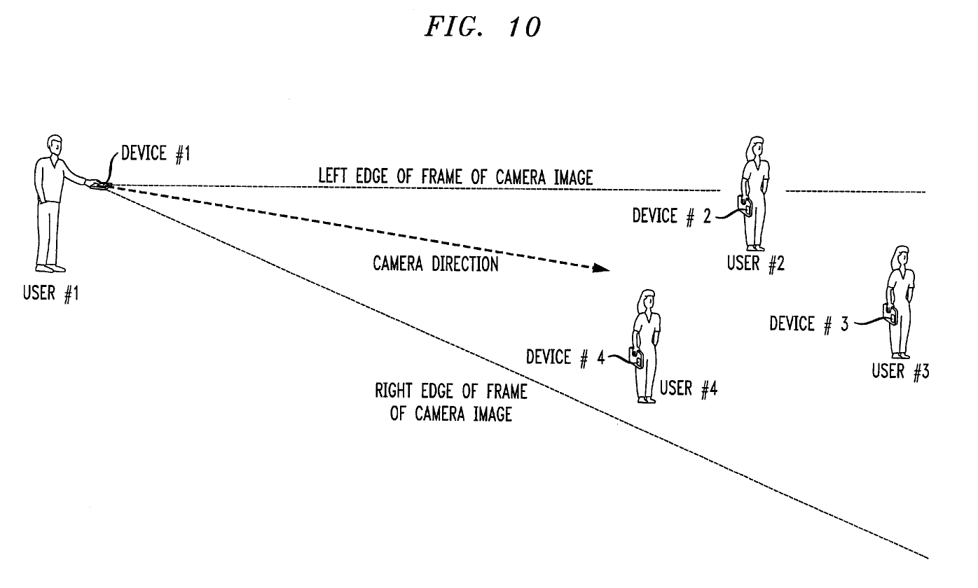

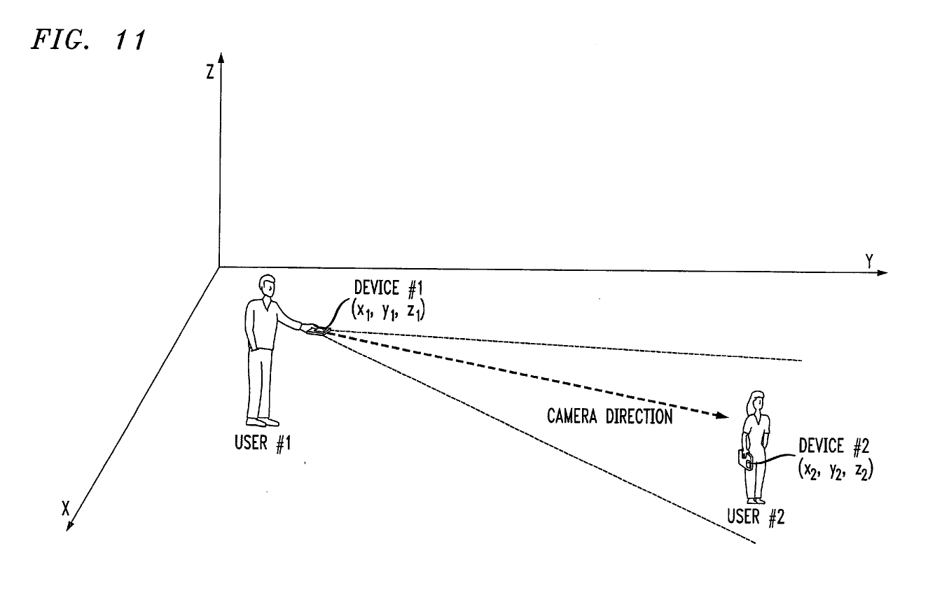

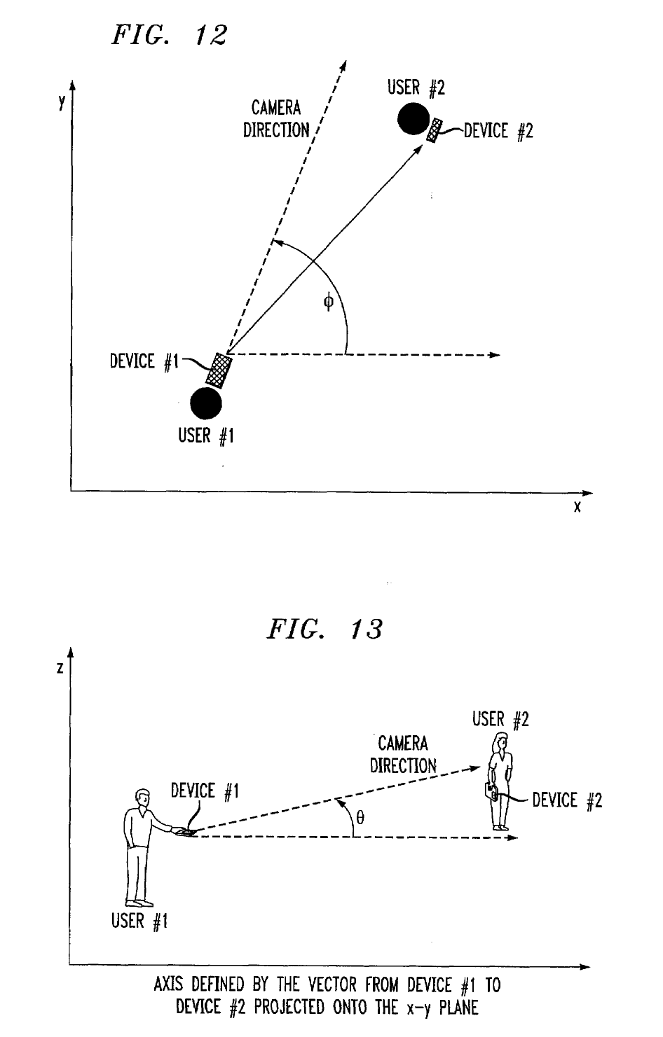

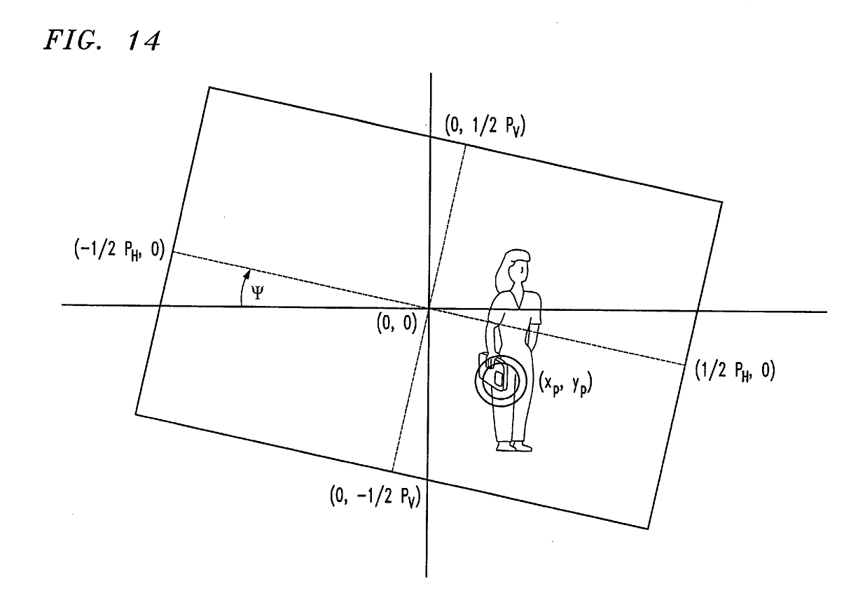

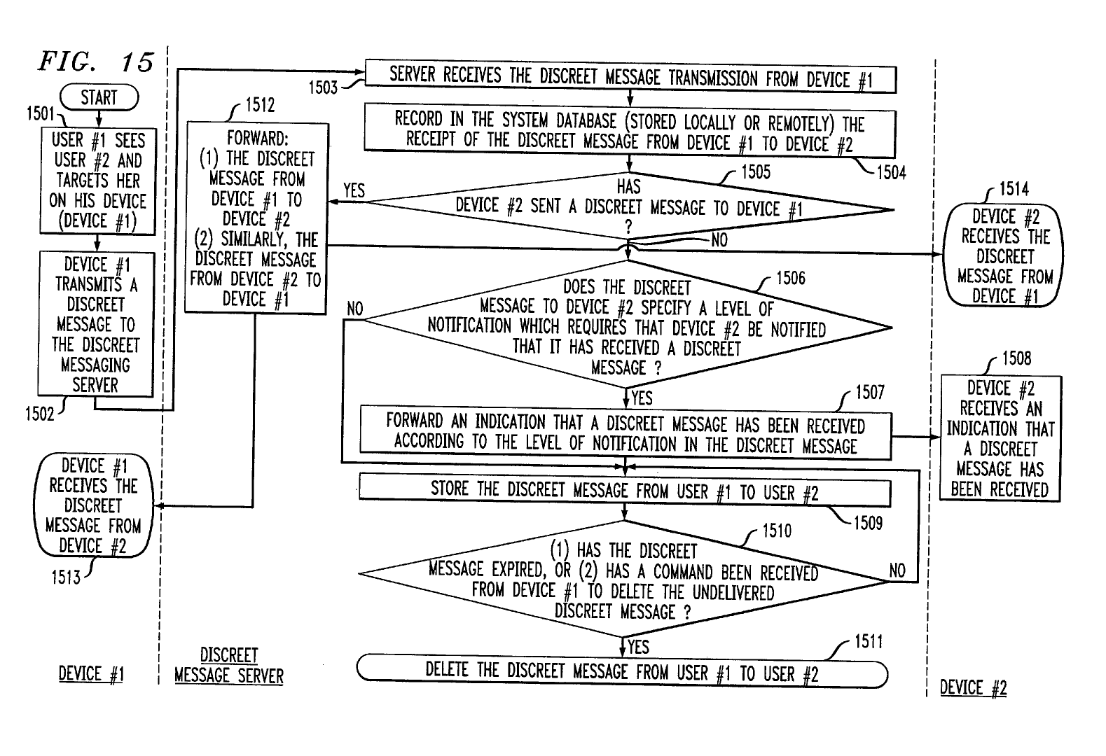

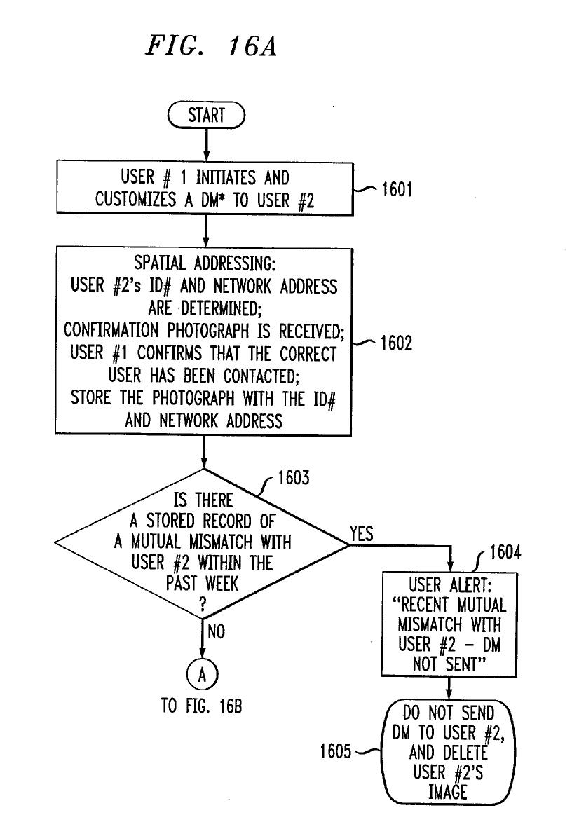

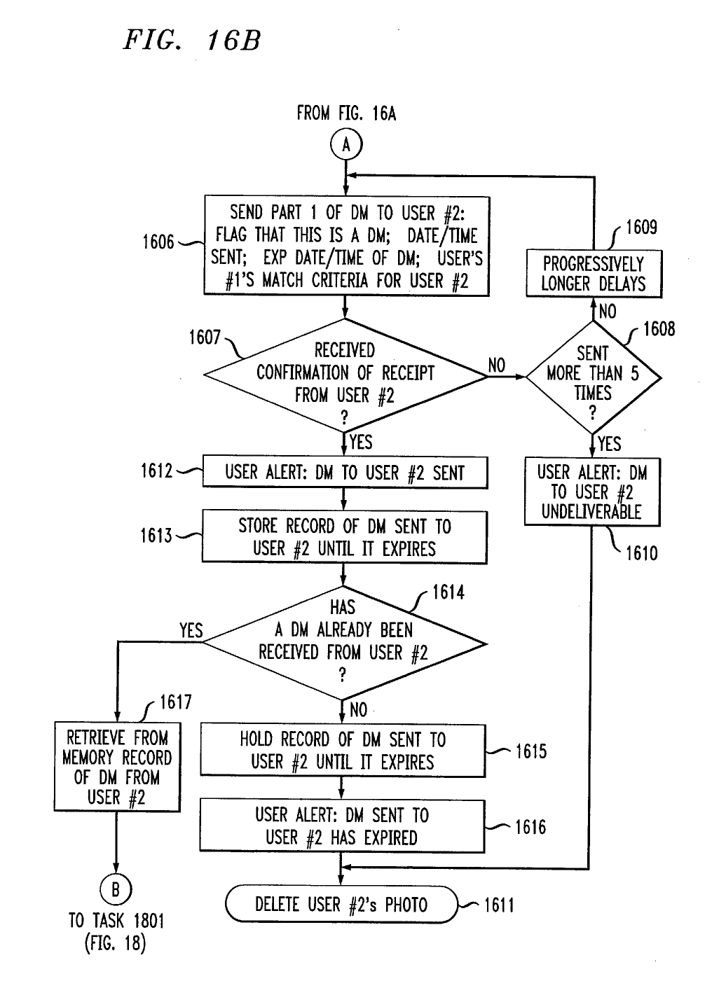

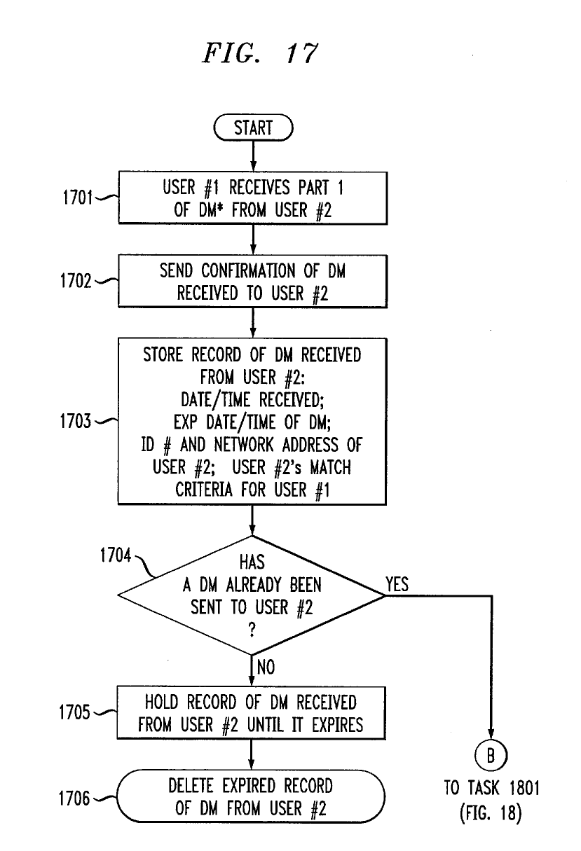

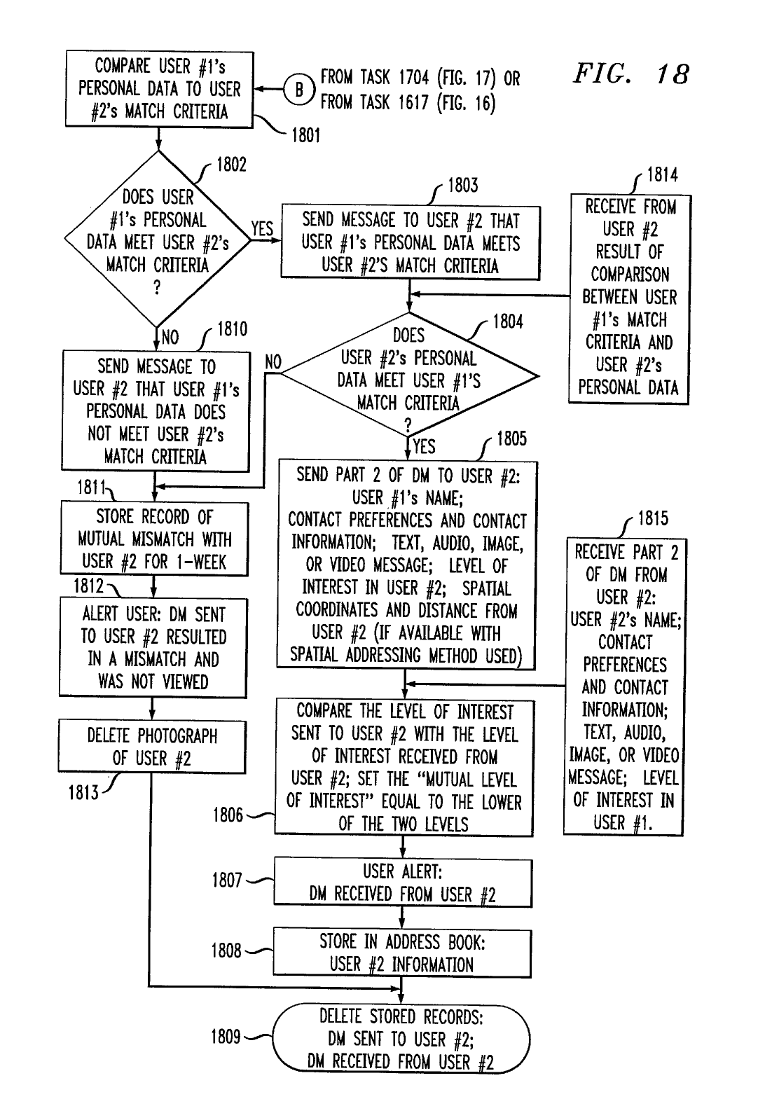

Processor 701 is a general-purpose processor, in well-known fashion, that is capable of interacting with memory 702, transceiver 703, and input/output 704 in well-known fashion, and that is additionally capable of performing the functionality described below and with respect to FIGS. 8 and 9.

Memory 702 is a non-volatile random-access memory, in well-known fashion, that stores the operating system and application software for processor 701.

Transceiver 703 is a bidirectional radio transceiver, in well-known fashion, that enables wireless terminal 101-i to communicate voice, text, and video with the other wireless terminals directly (e.g., through a Bluetooth network, etc.), through base station 602 (e.g., a WiFi access point, etc.), and with remote data processing system 603 via base station 602.

Input/output 704 comprises a keypad, display, camera, and acoustic transducers, in well-known fashion, which enable a user to communicate via voice, text, and video.

It will be clear to those skilled in the art, after reading this disclosure, how to make and use alternative embodiments of the present invention in which one or both of the First Person's terminal and the Second Person's terminal are wireline terminals. Furthermore, it will be clear to those skilled in the art, after reading this disclosure, how to make and use alternative embodiments of the present invention that are part of a different system (e.g., a wireless local area network, the Internet, a Bluetooth network, etc.) and, therefore, are distinguishable and addressable by an address (e.g., an IPV6 address, a MAC address, etc.) in a different address space. And still furthermore, it will be clear to those skilled in the art how to make and use alternative embodiments of the present invention for purposes other than dating and romance (e.g., to facilitate business dealings, etc.).

In accordance with the second illustrative embodiment, the First Person's terminal communicates at the physical layer with base station 602. Furthermore, in accordance with the second illustrative embodiment, the First Person's terminal communicates at the application layer with data processing system 603.

In accordance with the second illustrative embodiment, data processing system 603 continually runs software that enables each person to be both:
i. an admirer, and
ii. an admired person.

### The functionality depicted in FIG. 8 enables a person, via his or her terminal, to be an admirer, and the functionality depicted in FIG. 9 enables a person, via his or her terminal, to be an admired person.

With respect to task 801 in FIG. 8, the First Person sees the Second Person.

At task 802, the First Person determines one or more distinguishing factors for the Second Person by capturing an image (e.g., taking a picture, etc.) of the Second Person with his or her terminal. When the captured image comprises two or more people, the First Person can crop the image to isolate the Second Person in the image.

At task 803, the First Person transmits the image (or image as cropped as necessary in task 802) to data processing system 603, which contains a database of image/username pairs. As part of task 803, data processing system 603 uses facial recognition software, in well-known fashion, to match the received image to one of the images in its database, and, therefore acquires the filtering criterion (e.g., username) for the Second Person. Data processing system 603 then notifies the First Person that it has successfully identified the Second Person.

At task 804, the First Person Indicates to data processing system 603, via his or her terminal, his or her Interest in communicating with the Second Person and does this by directing data processing system 603 to reveal to him or her the existence and complete content of any messages that have been sent, or might be sent, from the Second Person (as identified by his or her filtering criterion). In accordance with the second illustrative embodiment, the First Person expresses either:
(1) an active interest to communicate with the Second Person, or
(2) a passive interest to communicate with the Second Person

When the First Person expresses an active interest In communicating with the Second Person, the First Person's terminal sends a message to the Second Person through data processing system 603 using the filtering criterion determined in task 802. The message comprises:
i. an Indication of the identity of the First Person (e.g., the identity of the First Person, an Image of the First Person, etc.), and
ii. the First Person's filtering criterion (e.g., Bluetooth network address, etc.),
iii. a subject (e.g., “Message From An Admirer,” etc.), and
iv. content (e.g., “Can I buy you a drink?” etc.).

Whether the First Person expresses an active Interest or a passive interest, as part of task 803, the username of the Second Person is stored in a List of Admired Persons that is permanently stored In data processing system 603. An example of such a list is depicted in Table 3.

TABLE 3
List of Admired Persons
UserName
(filtering criterion)
Emilee9
Stormyrain
Supergirl175
Shannas

At task 805, data processing system 603 determines if the Second Person has previously expressed an interest in communicating with the First Person. This is necessary because data processing system 603 might have previously received a message from the Second Person, which message was partially or wholly hidden from the First Person by data processing system 603. This situation Is likely because the First Person might be performing this series of tasks in response to the receipt of a message from the Second Person. In either case, the Second Person's username is searched for in a List of Admirers (i.e., those people who have sent the First Person a message that was partially or wholly hidden from the First Person) that is permanently stored in the data processing system 603. An example of such a list is depicted in Table 4.

TABLE 4
List of Admirers
UserName
Almondpetal
Beany7
WTX312
Anitamina
Fatoumata

### How and when Table 4 is populated is described below and with respect to FIG. 9. When the Second Person's username is within the list of Admirers, control passes to task 806; otherwise control stops.

At task 806, data processing system 603 directs the First Person's terminal to alert the First Person to the fact that the Second Person has previously sent the First Person a message, and, therefore, has previously expressed an interest to communicate. As part of task 805, data processing system 603 transmits to the First Person's terminal the entire messages that was received from the Second Person.

At task 807, data processing system 603 initiates a text-messaging session between the First Person's terminal and the Second Person's terminal so that the First Person and the Second Person can freely communicate. It will be dear to those skilled in the art, after reading this disclosure, how to make and use alternative embodiments of the present invention in which the communication in task 806 is through text, voice, or video.

FIG. 9 depicts a flowchart of the salient tasks performed by data processing system when a message is sent from a Third Person, who might or might not be the Second Person, to a Fourth Person, who might or might not be the First Person.

At task 901, data processing system 603 receives a message transmitted from a Third Person to a Fourth Person, wherein both persons are identified by their respective usernames. The message comprises:
i. an Indication of the identity of the Third Person,
ii. the Third Person's username,
iii. a subject, and
iv. content.

At task 902, data processing system 603 determines if the Fourth Person has ever expressed an Interest (either active or passive) In communicating with the Third Person. Task 902 is accomplished by searching for the Third Person's username in the Fourth Person's List of Admired Persons. If the Third Person's username is in the Fourth Person's List of Admired Persons, then control passes to task 903; otherwise control passes to task 905.

At task 903, data processing system 603 transmits a message to the Fourth Person's terminal to alert the Fourth Person to the arrival of the message and provides the user with the message.

At task 904, data processing system 603 initiates a text-messaging session between the Third Person's terminal and the Fourth Person's terminal so that the Third Person and the Fourth Person can freely communicate. It will be clear to those skilled in the art, after reading this disclosure, how to make and use alternative embodiments of the present invention in which the communication in task 904 is through text, voice, or video.

At task 905, data processing system 603 alerts the First Person to the arrival of the message and provides the First Person with:
i. the subject of the message.
   Data processing system 603 withholds from the Fourth Person's terminal:
i. information that identifies the Third Person, and
iii. the Third Person's terminal's username, and
ii. the content of the message.
   Upon the receipt of the message from the Third Person, the Fourth Person might be prompted to look around and consider sending a message to someone he or she admirers. If that happens to be the Third Person, then a connection is made. If not, the Fourth Person might be prompted to look around and consider sending a message to someone he or she admirers. As part of task 905, data processing system 603 adds the Third Person's terminal's username to its List of Admirers, as depicted in Table 4. After task 905, control stops. In some alternative embodiments of the present invention, all of the message and also its existence are withheld from the admired person until the admired person expresses an interest in communicating with the admirer.

It will be clear to those skilled in the art, after reading this disclosure, how to make and use alternative embodiments of the present invention in which the First Person's terminal withholds some or all of the subject or content of the message transmitted from the First Person.

It is to be understood that the illustrative embodiment of the present invention is merely one embodiment of the invention and that many variations of the illustrative embodiment can be made and used without departing from the scope of the invention. For this reason, these variations are to be included within the scope of the following claims and their equivalents.

### EXAMPLE

### Embodiments

The present Invention is primarily a method of establishing and facilitating electronic communications between people that are in physical proximity to each other. It is partially embodied in the form of a small mobile device, either its own dedicated device, or as enhanced functionality to other mobile devices such as, for example, PDA's (personal digital assistants) or cellular telephones. The device may include a small digital camera which can record both single still images as well as video images, the means to enter text and record audio, the ability to transfer information (text, audio, image, or video) from a computer to the device as an alternative to entering information directly into the device, the ability to display text or images and playback audio or video, a programmable microprocessor, and memory storage and retrieval functions—all commonly available features on today's cellular telephones and PDA's. In addition, the device may have additional hardware capabilities.

The primary purpose of this invention is to facilitate communication between people that are in physical proximity to each other. It does this by providing a user of the invention with the following capabilities: (1) the ability to communicate electronically (text, voice, Image, or video) to specific other individuals (or vehicles—automobiles, motorcycles, etc.) In his or her environment that have been identified visually, but for whom contact information (telephone number, email address, etc.) may not be known, (2) the capability of discreetly communicating interest in other people without risk of rejection, while at the same time protecting recipients from unwelcome communications, and (3) the ability to mutually reveal commonalities that the user shares with particular other users. It is expected that the primary application of the invention will be to facilitate romantic relationships, although other social, business, civic or military applications can be foreseen.

All potentially compatible people can be separated into two categories based upon the criterion of whether or not one is aware of them. The first category consists of all the people that one is not aware of because one has not met them, seen them, or even heard of them. This is the group addressed by online dating services, newspaper personal ads, and match makers in that they alert the individual to the existence of specific other Individuals who may be compatible. Newer technological developments that serve this same population are hand-held devices such as the Japanese Lovegety and the Spotme device that alert the user to potentially compatible people in the user's immediate environment that would have otherwise gone unnoticed. Even more recently a cellular telephone company, AT&T Wireless, in conjunction with an online dating service, Match.com, has offered a profile matching service to cellular telephone users that is activated when users are in the same physical proximity. All of these services alert the user to potentially compatible partners that the user otherwise would not know about.

The second category of people consists of all the people that one does already know about because one has already met them, heard of them, or at least noticed them. This group includes friends, classmates, colleagues, acquaintances, and the largest group—strangers that one becomes aware of in the normal course of everyday activity in a grocery store, elevator, subway train, restaurant, etc. When it comes to having a relationship with someone among this group of people, one is aware of which individuals one is interested in and which individuals one is not interested in. The issue then is not who to date, but rather how to go about making that happen. Thus, among this group, there is little demand or need for services which offer to match people to each other. There is, however, a need to facilitate developing relationships with the people that one is already interested in.

Among this group of people that one has already noticed and has an interest in, the biggest hindrance to meeting for friendship or dating purposes is a reticence to acting on one's attraction by approaching the person of interest and expressing (directly or indirectly) one's feelings or intentions. There are three main obstacles that prevent people from approaching others that they are attracted to:

(1) If the person of interest is a stranger, it may be awkward to approach him or her because the social circumstance may not be appropriate, conducive, or convenient to physically approach the person. For example, the person of interest may be talking on the telephone, or talking to a group of friends.

(2) People are uncertain of whether or not the interest is mutual, and they are afraid of rejection. If the person of interest is already known, then the consequences of rejection can be quite significant.

(3) It may be awkward to approach a stranger simply because there is not a logical pretext to do so. In addition, conversation can be awkward until points of commonality are identified.

The first obstacle, awkwardness in approaching a stranger, could be largely overcome with simple text messaging. No matter what the social situation, a text message could be discreetly sent to the person of interest. But there is a critical problem: the contact information (telephone number or email address, for example) of the person of interest is not known.

The second obstacle, the risk of rejection and humiliation, could be overcome if there was a common third party known to both people to whom they could both safely and discreetly disclose their interest. Then, if the interest is mutual, the third party could tell them both about their mutual attraction. If, however, only the first person expresses interest in the second person, then the third party would say nothing to the second person, and the second person would never know that the first person was interested, and nothing would be risked or lost. Of course, it is highly improbable that a third party known to both people would be present when needed, especially if the two people are strangers.

As a substitute for a third person, it is possible to use a computer as the third party which mediates the interaction between people. There are at least a couple of services now that do this to some degree. A web site, SecretAdmirer.com offers a service whereby a person can have an anonymous email sent to a second person that simply tells that person that they have a secret admirer, and then prompts this second person to send an anonymous email to others. Then if the second person happens to send a “secret admirer email” to the first person, then both people will be notified of the other's interest. There also exists a similar service offered by a Swedish company, Blue Factory, called “Flirtylizer” that uses cellular telephones instead of the internet. However, both of these services have the same critical limitation: they require that the email address or telephone number of the target person be known. Thus, these services cannot be used with strangers.

The third obstacle, awkwardness in communicating with a stranger, can also be overcome with the help of a computerized third party. If users shared information about themselves with the third party, then the third party could reveal to both parties those commonalities to both parties. In this way, people could immediately talk about those people, places, or activities that they have in common. Having things in common with another person engenders trust and openness because “that person is like me”. Online dating services also allow individuals to identify commonalities. But these services use the commonalities to match people to each other and then and alert them to each other's existence. These services therefore are of no help if one meets someone in the real world, outside the confines of cyberspace. There are also social networking web sites like Friendster or Orkut that allow users to identify other people, and networks of people, that users have in common. But again, these services are only valuable to identify other individuals online. For people who have already identified each other in the real world and are interested in meeting, these services are not helpful at all as tools for facilitating introductions and initiating conversation.

The current invention has been devised to overcome all three of these obstacles to people expressing interest and getting to know other. It has two primary functions:

Function #1: Perceptual Addressing

Perceptual Addressing is the ability for one person, User #1, to establish a communications channel with another person, User #2, that User #1 can see in his or her environment but for whom no contact information is known. These communications can be in the form of messages sent from one person to another or can be in the form of live interactive two-way audio and/or video communications; and the content of these communications can consist of any form of digital media including text, images, video, and voice. Devices in the same vicinity can communicate with each other via direct device-to-device transmission, or alternatively, devices can communicate via a wireless connection to a network—the internet, cellular telephone network, or some other network.

Function #2: Discreet Messaging

“Discreet Messaging”, is specialized form of messaging which uses an automated system as a “trusted third party” (either a system of two handheld devices—those of the two individuals communicating, or a third-party server with which each handheld devices communicates) which will arbitrate the disclosure or non-disclosure of various portions of the content of messages, or even the disclosure or non-disclosure of the fact that a message was sent, according to agreed-upon rules of the specific application of Discreet Messaging. Moreover, particular aspects of the content received by both users can be variable. In other words, User #1 could send a DM to User #2 and the content of the message actually received and viewed by User #2 could change depending upon the content of the DM sent from User #2 to User #1—and vice versa. As an example of particular implementation of Discreet Messaging applied to the field of dating, a more specific three-part description is offered:

Part (a) Discreet Messaging is the ability for User #1 to send a message indicating interest to User #2 and be assured that User #2 will never know that a message was sent, unless (i) User #2 independently sends a message indicating interest to User #1, and (ii) that User #2 meets minimal compatibility requirements specified by User #1, and (iii) User #1 meets minimal compatibility requirements specified by User #2. Restated another way: for either user to be aware of and view a Discreet Message (DM) from the other user, both users must send DM's to each other, and both users must meet minimal compatibility requirements specified by the other user.

Part (b) In the case that Part (a) above is satisfied and both users are able to view DM's sent by the other, Discreet Messaging provides for the optional disclosure of personal information to the other user only in the case that both users share that information in common. Examples of commonalities that may be disclosed are people that both users know and the specific social connections that link them together, places both users have lived or visited, common religion, common languages spoken, common political or philosophical viewpoints, etc.

Part (c) In the case that Part (a) above is satisfied, the content of particular aspects of a message expressed to each user can depend upon the content expressed by both users. For example, If User #1 expressed her interest in User #2 as “interested”, and User #2 expressed his interest in User #1 as “love at first sight”, then the level of interest that would be actually communicated and received by both users is the lower of the two levels—“interested”. In this way neither user is aware of an imbalance of interest. (Proper implementation of what contingencies are allowed in any particular application can solve any circularity problems.)

### Example #1

### Of Perceptual Addressing

Bob is riding a city bus on his way to a dentist appointment. At the next stop he notices an attractive woman, Sarah, get on the bus and make eye contact with him before taking a seat a few rows in front of him. He knows he will never see her again unless he acts immediately. So using his handheld device, he sends to her a brief message which includes his contact information—his telephone number, email address, and device network address. He immediately receives a confirmation message saying “message delivered”. He hopes she will respond to his message.

### Example #2

### Of Perceptual Addressing

John is driving from Seattle to San Francisco. It is getting late, and he needs to find a hotel for the night. He is driving behind a large semi and thinks that perhaps the driver can recommend a place to stay nearby. He takes out his mobile device and presses a button. He sees two license plate numbers displayed. He selects the one that corresponds to the truck in front of him. He then holds his device to his ear. Just then, Pete, in the pickup truck in front of John, picks up his mobile device and sees on its display, “call from license plate # AYK-334”. Pete then presses a button and says “how's it going?” They proceed to have a brief cellular telephone conversation in which John asks about hotels in the area and Pete makes a couple of recommendations.

Example of Discreet Messaging:

A girl sitting in a cafe sees a guy walk in that she is attracted to and would like to meet. Using her handheld device, she sends him a DM that she is interested. Her device indicates that a message was successfully sent but not viewed. He is not aware that a message was sent to him because his device gives no indication that a message was received. She is glad that he is not aware of the message she sent because she would not want him to know that she liked him unless she was sure that he also liked her. In fact, she would not have sent the message at all unless she had that assurance. A few minutes later, her device alerts her that she has just received a DM, and that the DM that she sent to him was made viewable. She looks at her device and it indicates the date and time that she received his DM to her, as well as the date and time that she sent her DM to him. Also displayed is a small image of the guy who sent her the DM (so she can identify and/or remember him) as well as his first name, a message saying “contact: in-person, telephone, email”, and his cellular telephone number and email address. In addition, her device also displays things she has in common with him (they both have an ancestor from Italy and they both loved the movie “The Matrix”), and how they are connected socially (her friend Beth Johnson knows Peter Griffin who knows his friend David Gross). Meanwhile, because she has already sent a DM to him, the moment he sends a DM to her, the DM that she sent to him is displayed on his device. The display on his device includes her image, a fictitious first name that she uses to protect her identity, a message saying “contact: in-person, email”, an anonymous email address which she uses only for dating purposes, and the same commonality information which appeared on her device. He is normally shy, but thrilled that she is also interested in him, he approaches her and introduces himself. They immediately begin talking about their connection through Peter Griffin.

System Features and Description

I. Unique Identification

Whenever one device makes a transmission to another device, regardless of whether that transmission is a broadcast to all nearby devices or a transmission addressed to one particular device, that transmission includes the unique address information of the sending device: a unique identification number (device ID#) and a network address (for example, telephone number, IP address, email address). It should be noted that, for security reasons, the device ID# and network addresses of other devices should be available only to the software system of each device and inaccessible to the user.

II. Transmission Methods

This invention is compatible with a wide variety of methods of transmitting information and, depending upon the method of Perceptual Addressing used, may include more than one mode of transmission. The modes of wireless transmission could include various technologies, frequencies and protocols—for example, radio frequency (RF), infrared (IR), Ultra Wide Band (UWB), WiFi (802.11) or any other suitable wireless technology in current use or yet to be invented. In addition to wireless means of transmission, non-wireless means may also be used.

The means of transmission between devices is transparent to users and may be either direct (device to device) or indirect via a wireless connection to a network such as the internet, cable networks, satellite networks, telephone networks, cellular telephone networks; or some combination. There may also be third-party devices mediating the communications between the users' devices. Transmissions between devices may be encrypted to prevent other devices, which are not sharing the same application, from having access to content that is intended to exist only temporarily and may be confidential.

This invention is agnostic with regard to the type of communication which is established between devices. For example, the communication can consist of sending and receiving individual messages and media files, or alternatively the communication can consist of a live streaming of audio and video in both directions simultaneously as in a telephone conversation or video conference.

III. Methods of Perceptual Addressing

If a user detects (sees or hears) someone to whom they want to communicate electronically, there must be a way to target the intended receiver. The difficulty is that the user will not usually have an address for the intended recipient—no device ID#, no telephone number, no email address, etc. Typically, the only information the user has is the target individual's approximate location relative to the user and the target's visual appearance. In some cases the user also may be able to hear the target individual's voice, although this characteristic would be less useful for users who have adequate eyesight. The goal of Perceptual Addressing is therefore to go from this limited subjective information about the target person or target vehicle to the ability to address communications to the target person's device.

There are four essential (non-sequential) tasks that all forms of Perceptual Addressing must perform:
1. Enable the user to specify one target person or target vehicle out of many possible targets. Using his or her device, the user must (a) specify one person/vehicle out of many (b) within the user's physical range of being able to directly perceive that person/vehicle (c) based upon one or more distinguishing characteristics that are (d) experienced subjectively by the user. There are three types of distinguishing characteristics: macroscopic appearance, spatial position relative to the user, and/or subjective voice quality. Some examples of a user specifying one target person/vehicle out of many: pointing the user's device—which contains a directional transmitter—at an intended target person, selecting one image of a person that resembles a target person out of several images received from a server, pointing with a camera to capture an image and then selecting a portion of the resulting image that resembles the target person, walking up close to the target person and scanning their RFID tag, selecting one voice sample—that resembles the sound of a target person's voice—out of several voice samples received from a server, inputing into the user's device a license plate number that is seen on a nearby car, etc.
2. Determine identifying characteristic(s) of the target person, target person's vehicle or target person's device (assuming the target person is carrying the device). The identifying characteristic is a characteristic that allows the identity of the target person to be determined. It may be related or unrelated to the distinguishing characteristic used above to specify one target out of many potential targets. In contrast with the distinguishing characteristic, the identifying characteristic need not be perceived by the user. Some examples of identifying characteristics: biometric profiles of the face, ear, retina, or voice, spatial position, transmission of ID or address emanating from the target person's device, license plate number, etc.
3. Associate the distinguishing characteristic(s) of the target person/vehicle with the identifying characteristic(s) of the target person/vehicle/device. This association can be made either before or after the user specifies which person/vehicle is the intended target. Examples of making this association: (a) pointing a camera on a device at a target person to capture biometric data associates the relative position of the target person (distinguishing characteristic) with the biometric profile of the target person (identifying characteristic); (b) a data processing system sends to the user's device images paired with device ID's of other users in recognition proximity—in this case the association is made before the user selects the intended target person.
4. Associate identifying characteristic of the target person/vehicle with the telecommunications address of the target person's device. This process may occur on the user's terminal or on a data processing system. There may be one or more intermediate associative steps.

Once the correct device ID# and/or network address of the intended recipient have been obtained, the Perceptual Addressing task has been completed. There are no restrictions on the varieties of subsequent communication between devices.

Image Confirmation

Because visual appearance and relative spatial location are the primary ways (less common ways are distinctive voice quality and distinctive smell) in which a user specifies the target person (if that person is a stranger), image confirmation often plays an important role in the Perceptual Addressing process. The user initiating contact needs to verify that the individual that he or she intended to contact was indeed the individual that was actually contacted. For this reason, it is helpful for users to have a digital image stored on their device of either their face, their body showing the clothes they are currently wearing, the exterior of the car they are currently driving, or the license plate number (image or text) of the car they are currently driving. For many methods of Perceptual Addressing, devices automatically send this image to any other device (which is part of the same application) upon request. It is important, however, that these images be used only for identification and confirmation purposes. For this reason, identification and confirmation images of other people which are stored on a user's device should have a very short lifetime (measured in seconds or minutes) after which time they are automatically deleted. The length of time that these images are stored on a device will depend on a number of factors including whether or not the image is of another person to whom a communication was actually made, and whether the image of another person was received as part of a communication from that person or received as part of the confirmation process when initiating a communication to that person.

For the process of visual confirmation, users need a method to input images of themselves into their device so that their images can be transmitted to other devices upon request. In order for users to input their own images into their devices, it is convenient for each device to be equipped with a digital camera similar to those currently in some cellular telephones. In order for users to effectively take photographs of themselves, it is helpful for the camera lens to be able to face the same direction as the display of the camera image. Having an integrated digital camera allows users to frequently update their image so that it closely matches their current appearance—critical in order for other people to correctly verify that they have contacted the person they intended to contact.

Methods of Determining Spatial Position

Several methods of Perceptual Addressing depend upon the ability to determine the spatial position of users and their potential targets. These methods require the use of spatial position technology, either currently existing or yet to be invented, that allows the determination of position to an accuracy of several centimeters. The particular method of determining position is not central to this invention and there are several methods that would suffice. (As an example, the method described in the paper “A High Performance Privacy-Oriented Location System” in Proceedings of the First IEEE International Conference on Pervasive Computing and Communications (PerCom2003), pages 216-223, would be adequate. Other positioning systems incorporating GPS, WiFi, UWB, RF triangulation, infrared, ultrasound, RFID, or any other technologies which would allow the position of each device to be accurately determined within several centimeters would also be adequate.

Following are descriptions of several different methods of Perceptual Addressing. These methods may be used alone or in combination.

Method #1: Non-Directional Transmission

A non-directional signal is broadcast to all devices in recognition proximity. The signal contains the device ID# and network address of the transmitting device (Device #1) as well as a request for all receiving devices to send their own device,ID#'s and addresses as well as a thumbnail image of their user to the requesting device. The user initiating the request (User #1) reviews all the images received, and then by selecting the image of the person that she is trying to contact (User #2), the user is actually selecting the address of User #2's device (Device #2). With this method a user will receive as many images as there are users in the area. The advantages of this method are: a) it doesn't require that the user be particularly close to the target; and b) it is currently viable everywhere because it doesn't require the existence of a location technology infrastructure. This method consists of the following steps:
(1) User #1 sees someone, User #2, to whom she wants to communicate, and instructs her device using the device interface (she presses a button, for example) to contact all other devices in the immediate vicinity and obtain images of their users.
(2) User #1's device (Device #I) then broadcasts a non-directional unaddressed transmission to all other devices within range. The transmission includes User #1's device ID# and network address, as well as a request that images be sent to Device #1.
(3) Each device receiving the request responds automatically (without user awareness) with a transmission addressed to Device #1, sending its own device ID# and network address, as well as a image of its user. (Only Device #1 will receive these transmissions as other devices will ignore an addressed transmission it if it is not addressed to them.)
(4) User #1 reviews the images received from all devices and selects the image of User #2, thereby selecting Device #2's device ID# and network address.
(5) Device #1 initiates an addressed communication to Device #2. The means of transmission can be either direct (device to device, if the two devices are in the same general vicinity) or indirect (via a network to Device #2's network address).

Method #2: Non-Directional Transmission to Devices within a Limited Radius

This method is identical to Method #1 with the modification that the initial request for user images is made with a more limited signal strength, requiring User #1 to be within a few feet of the target person (User #2), thus limiting the number of other devices that will be contacted, and in turn limiting the number of images that will be received. There are two different user options for how to control signal strength: (a) the user specifies a desired radius of effectiveness (selection may be made in terms of a unit of distance, “5 feet”, for example, or in terms of general ranges, “far”, “medium”, and “close”, for example) which then determines the signal strength; or (b) the user specifies the maximum number of people (selection may be made in terms of specific numbers of people, “3 people”, for example, or in terms of general numbers of people, “very few”, “some”, or “many”, for example) that should be contacted: the signal strength then starts at a very low level and increases until the maximum number of people have been contacted (as measured by the number of responses received). The initial transmission requests device ID#'s, network addresses, and associated images. User #1 then selects the image corresponding to the intended recipient, thus selecting the device ID# and network address of the correct target. This method consists of the following steps:
(1) User #1 sets the default transmission distance on her device (“5 feet”, for example).
(2) User #1 sees someone, User #2, to whom she wants to communicate. She walks to within five feet of User #2 and instructs her device (Device #1) via its user interface (she presses a button, for example) to contact all other devices within five feet, and obtain device ID#'s, network addresses, and images from each device. (Alternatively, User #1 could have controlled the signal strength of the initial broadcasted request by specifying the maximum number of people that should be contacted so that her device gradually increased signal strength until the maximum number of responses is received. If she had sent the maximum equal to one person, the result would be that only the person closest to her would be contacted.)
(3) Device #1 broadcasts a non-directional transmission to other devices with enough signal strength to effectively reach approximately 5 feet, under “normal” conditions”. The transmission includes Device #1's device ID# and network address, as well as a request for the device ID#, network address, and image from other devices.
(4) Each device receiving the request responds with a transmission addressed to the device making the request, sending its own device ID# and network address as well as a image of its user.
(5) Device #1 receives the device ID#'s, network addresses, and images from all other users in the area.
(6) User #1 selects the image of User #2, thereby selecting User #2's device ID# and network address.
(7) Device #1 initiates an addressed communication to Device #2. The means of transmission can be either direct (device to device, if the two devices are in the same general vicinity) or indirect (via a network to Device #2's network address).

Method #3: Directional Transmission to Other Users' Devices

This method is identical to Method #1 except that instead of Device #1 making an initial transmission in all directions, the transmission is focused in a relatively narrow beam toward the target person (User #2), thus reducing the number of other users contacted by the transmission, while at the same time allowing User #1 to be at a relative distance from User #2. The transmission uses frequencies in the range of 100 GHz to sub-infrared in order to balance the dual needs of creating a highly directional transmission from a small handheld device with the need to penetrate barriers (such as clothing and bodies) between the transmitting device and receiving device. This method consists of the following steps:

(1) User #1 sees someone, User #2, to whom she wants to communicate.

She aims her device (Device #1) at User #2. User #1 instructs her device via its user interface (she presses a button, for example) to contact all other devices in the direction of User #2 and obtain device ID#'s, network addresses, and confirmation images of those users.
(2) User #1's device (Device #1) sends a directional transmission to all other devices in the target user's direction. The transmission includes Device #1's device ID# and network address, as well as a request that confirmation images be sent to User #1.
(3) Each device receiving the transmission responds with a transmission addressed to Device #1, sending its own device ID# and network address, as well as a confirmation image of its user.
(4) Device #1 receives device ID#'s, network addresses, and confirmation images from all other local users in the direction of User #2.
(5) From the confirmation images received, User #1 selects the image of User #2, thereby selecting the device ID# and network address of User #2's device, Device #2.
(6) Device #1 initiates an addressed communication to Device #2. The means of transmission can be either direct (device to device, if the two devices are in the same general vicinity) or indirect (via a network to Device #2's network address).

Method #4: Directional Transmission to RFID Tags

As an alternative to configuring a directional transmission that will penetrate obstructions, the emphasis is placed on a high frequency highly directional beam (infrared, for example) without regard for its penetration properties. It involves the use of one or more tiny Radio Frequency Identification Tags (RFID) tags clipped onto the outside of clothing of each user which, when scanned by the devices of other users, transmits the device ID# of the target user's own device to the interrogating device. In order to scan the RFID tag(s) of a target user, devices have highly directional scanning capability using a high-frequency signal (infrared, for example). User #1 points her device (Device #1) toward the person of interest (User #2). Then, depending on how highly focused the scan and how accurate the aim of User #1, the beam will contact the RFID tags of one or more individuals, including User #2, which will then transmit device ID#(s) back to Device #1. Device #1 then sends a non-directional transmission addressed to each of the devices contacted. The transmission contains User #1's device ID# and network address, and also a request for a confirmation image of the other users. After confirmation images are received from all the devices contacted, User #1 selects the image of the intended recipient, User #2, thus addressing a communication to only that individual. With this method a line of sight is required between User #1's device and the RFID tags of other users, and there is a range limitation as to how far passive RFID tags can transmit back to the scanning device. This method consists of the following steps:
(1) User #1 sees someone, User #2, to whom she wants to communicate.

She aims her device (Device #1) at User #2. User #1 instructs her device via its user interface (she presses a button, for example) to contact all other devices in the direction of User #2.
(2) Device #1 transmits a high-frequency (infrared, for example) directional signal in the direction of User #2. This signal, containing Device #1's device ID# makes contact with the RFID tags of one or more users.
(3) Each RFID tag which receives the transmission from Device #1 then makes a transmission addressed to Device #1's device ID# and containing the device ID# of its user.
(4) Device #1 receives the device ID#'s from all RFID tags contacted and then sends a non-directional transmission addressed to each of those device ID#'s. These transmissions include Device #1's device ID# and network address as well as a request for a confirmation image of the user. If any of the other devices cannot be contacted with a direct transmission because they are now out of the immediate area, or for some other reason, then a transmission is made to the device's network address.
(5) Each device receiving a request for a confirmation image then transmits a user's image to Device #1.
(6) Device #1 receives all confirmation images and displays them. User #1 selects the image of the user she intended to contact, User #2, thereby selecting Device #2's device ID# and network address.
(7) Device #1 initiates an addressed communication to Device #2. The means of transmission can be either direct (device to device, if the two devices are in the same general vicinity) or indirect (via a network to Device #2's network address).

Method #5: Non-Directional Transmission to RFID Tags

This method is identical to Method #4 with two important differences: (a) The transmission to scan the target person's RFID tag is non-directional; (b) Because the scanning is non-directional, scanning must be very short range. In order to select the person of interest, User #1 must stand very close to User #2 when activating the scanning transmission. It is also important that User #1 makes sure that there are not any other users within scanning distance.

Method #6: Directional Transmission to Intermediate RFID Tags

Similar to Method #4, RFID tags are worn by users who receive highly directional high-frequency transmissions from User #1's device (Device #1). But instead of transmitting a high frequency signal back to the Device #1, the RFID tag converts the incoming signal to a relatively low frequency radio frequency (RF) signal (that easily penetrates clothing and bodies) and then transmits this RF signal to its owner's device (at most only two or three feet away) by addressing it with the device's device ID#. As this signal carries Device #1's Device ID, network address, and a request for a confirmation image, after receiving the signal the target device makes a non-directional transmission addressed Device #1, sending its own device ID#, network address, and an image of its user. User #1 then needs only select the image of the person she intended to contact, User #2, in order to address subsequent transmissions to that person. Because the RFID tags do not transmit back to the initiating device, this solution does not have the range limitations of the previous method, although it still requires a line of sight between the device of the sender and the RFID tag of the receiver. This method consists of the following steps:
(1) User #1 sees someone, User #2, to whom she wants to communicate. User #1 aims her device (Device #1) at User #2 and instructs her device via its user interface (she presses a button, for example) to contact all other devices in the direction of User #2.
(2) Device #1 transmits a high-frequency (infrared, for example) directional signal in the direction of User #2. This signal, containing Device #1's device ID# makes contact with the RFID tags of one or more users.
(3) Each RFID tag contacted then transforms the signal to a much lower RF frequency and then transmits the same information, addressed to its user's device ID#. A low power transmission is adequate as the signal has to travel only a few feet (for example, from the RFID tag on the target person's lapel to the device in the target person's pocket).
(4) After receiving the transmission, the receiving device makes a transmission addressed to Device #1's device ID# which includes the recipient device's device ID# as well as a confirmation image of the recipient.
(5) Device #1 will receive and display one confirmation image for every device contacted. User #1 selects the image of the user she intended to contact, User #2, thereby selecting Device #2's device ID# and network address.
(6) Device #1 initiates an addressed communication to Device #2. The means of transmission can be either direct (device to device, if the two devices are in the same general vicinity) or indirect (via a network to Device #2's network address).

Method #7: Server Managed Image Identification

This method is similar to Method #1 with the exception that the images of nearby users, instead of being sent from the nearby devices themselves, are sent from a central server which also mediates communication between devices. The central server of this application has access to location information of all users as well as a database of all users containing their addresses, device ID#'s, and facial images. Upon request the server is able to send images of proximal users to a requesting device. This method consists of the following steps:
(1) User #1 sees someone, User #2, to whom she wants to communicate, and instructs her device, using the device interface (she presses a button, for example), to contact the central server and request images of other users currently in her proximity.
(2) User #1's device (Device #1) then transmits a request to the server. The transmission includes User #1's device ID# and network address, as well as a request that images be sent to Device #1.
(3) The server retrieves the necessary location information and determines which other users are within viewing distance of User #1. The server then transmits the images of those other users along with their associated device ID#'s to Device #1.
(4) User #1 reviews the images received and selects the image of User #2, thereby selecting Device #2's device ID#.
(5) Device #1 initiates an addressed communication to Device #2 via the central server by specifying Device #2's device ID#.

Method #8: Location Identification & Spatial Mapping

In this method each user's device determines its own location coordinates periodically (at least once per second is recommended), and broadcasts periodically (at least once per second is recommended) those coordinates, along with the device's device ID#, to other devices sharing this application in the immediate vicinity. (It would also be an acceptable solution for a centralized system to track the location of all devices and transmit to all devices the locations, device ID#'s and network addresses of all devices local to each device, updating that information periodically.) It is necessary for devices to have periodically updated position information about all local devices in order to take into account the motion of users. It should be noted that location coordinates need not be globally valid—locally valid coordinates are sufficient. Each device is therefore aware of the positions of all other devices nearby—both their device ID#'s and location coordinates. Devices then have the information necessary to display a two dimensional self-updating map of all other users in the immediate vicinity in which each user is represented by a small symbol. A device ID# and network address is associated with each symbol so that a user need only select the symbol associated with a particular person to address a transmission to that person.

To contact a person of interest, User #1 first views the map on her device and compares the configuration of symbols on the map with the configuration of people before her. She then selects the symbol on the map which she believes corresponds to the intended recipient. Her device (Device #1) then makes a transmission to User #2's device (Device #2) containing Device #1's device ID# and network address and a request for a confirmation image of User #2. Device #2 then transmits an image of User #2 to Device #1. User #1 then compares the image received to the actual appearance of the person she intended to contact. If she determines that she has contacted the correct person, then she instructs her device via the user interface to initiate communications with User #2. If, on the other hand, the confirmation image that User #1 received does not correspond to the person that User #1 intended to contact, then User #1 may select another symbol which could possibly represent the person she wants to contact.

[An alternate version of this method would not require the constant periodic updating of position information during periods in which there are no users in a local area performing perceptual addressing functions. Instead, this same process would operate only when initiated by a user via the user interface of his or her device (pressing a button, for example). Upon initiation, Device #1 would determine its own position (periodically for the next several minutes) and also broadcast a request for positions and addresses of all other devices in the vicinity. Upon receiving this request, each device would determine its own position (periodically for the next several minutes) and also broadcast (periodically for the next several minutes) its position and address. The rest of this alternate method is the same as the original method. The advantage of this alternate method is that it would save energy and bandwidth for devices not to be determining and broadcasting position when it is not needed or used. The disadvantage is that there is a short delay between the time User #1 initiates the positioning process and the time all user's positions are displayed on her device.

Yet another alternate version entails the above alternate method with the following changes: All devices maintain time synchronization to one-second accuracy by means of periodic time broadcasts via a network from a central server. All devices constantly update their position—at least once per second—and record what position they are at each point in time. This data is saved for a trailing time period, 10 seconds for example. Then, when a device makes a request of other devices for positions and network addresses, the request specifies the precise time for which position information is sought. Using this second alternative method then, devices only transmit their positions when there is a request for position information, yet there is no inaccuracy in position information introduced as a result of potential movement of each user between the time the request for position is made and the time each device assesses its own position.]

The advantages of this method are (a) it doesn't require a user to draw attention to himself or herself by aiming his or her device at another person; (b) it can precisely target just one person at a time; (c) it doesn't depend on making a “line-of-sight” connection; and (d) there are no range limitations other than the target person be in the same general vicinity. This method consists of the following steps:
(1) All devices periodically (at least once per second is recommended) determine their own position coordinates and broadcast those coordinates along with their device ID#'s to other devices in the immediate vicinity.
(2) User #1's device (Device #1) receives frequently updated location information from all other devices in its immediate vicinity.
(3) User #1 sees someone, User #2, to whom she wants to communicate.
(4) User #1 instructs her device via its user interface (presses a button, for example) to display a 2-dimensional map of the locations of all other devices in the immediate vicinity in relation to itself. Each of the other devices are represented on the display by a small symbol (which can potentially represent useful distinctions such as the sex of the user, or whether the user is participating in the same “application” such as “dating”, or “business networking”, etc.).
(5) The user selects the symbol on the display of her device which she believes corresponds to User #2, thereby selecting the device ID# of User #2's device (Device #2). If the user is not operating her device in a “confirmation mode”, then at this point addressed communications are initiated with User #2 which includes the transmission of an image of User #1, Device #1's device ID#, and Device #1's network address.
(6) If the User #1 does wish to operate her device in a “confirmation mode”, then Device #1 makes a transmission addressed to the target device that includes its own device ID#, network address, and a request for a confirmation image of the target user.
(7) Device #2 responds by sending a transmission addressed to Device #1 that includes its own device ID#, network address, and an image of User #2.
(8) User #1 views the image of User #2 on her display to confirm that it is the person she intended to contact.
(9) If the image received corresponds to the person she intended to contact, then she instructs her device (by pressing the “send” button, for example) to initiate an addressed communication to the target device. Device #1 also sends an image of User #1, Device #1's device ID#, and Device #1's network address to Device #2.
(10) If the confirmation image received from Device #2 does not correspond to the target user, then User #1 has the option of selecting a different symbol which could potentially belong to the target individual. If there is no symbol that corresponds to the target individual, then that individual either does not have a device which shares the same application, or that device is disabled, or that device is set in an “invisible mode” in which either it is not accepting communications at all, or it is not accepting communications from that particular sender.

Method #9: Virtual Beaming

This method is similar to method (6) except that it employs a different user interface, “virtual beaming”, for selecting which devices will be contacted. In addition to incorporating the location positioning technology of Method #8 (with the additional provision that absolute direction must be incorporated into the position coordinates returned by the positioning system—for example, given two position coordinates it must be possible to determine which position is further North and which position is further West), it also incorporates direction technology such as, for example, a digital flux-gate compass and/or a gyroscopic compass. Instead of a user targeting a person of interest by selecting a symbol on her display which she thinks corresponds to that person, she targets the person of interest by pointing her device at him and instructing her device via the user interface (pressing a button, for example) to contact that person.

Using the direction technology incorporated into the device in combination with the position technology already discussed, it can be determined with simple geometry which target individuals are positioned within a narrow wedge (in either two or three dimensions, depending on the sophistication of the positioning information) extending out from the user's position in the direction she is pointing her device: User #1's device (Device #1) has already received information as to her own position and also the device ID#'s and position coordinates of all other devices in the immediate vicinity. The direction that User #1's device was pointing when she targeted the person of interest can be represented as the “target vector”, which begins at User #1's position and extends in the direction determined by the direction technology in her device. For position information in 3-dimensions, a target volume can then be defined as the volume between four vectors, all extending from User #1's position—two lying in a horizontal plane and the other two lying in a vertical plane. In the horizontal plane, one vector lies X degrees counterclockwise to the target vector, and the other vector X degrees clockwise to the target vector, where X is a small value (5 degrees is recommended) which can be adjusted by the user. In the vertical plane, one vector extends in a direction X degrees above the target vector, and the other vector X degrees below the target vector

When User #1 points her device and “presses the button”, Device #1 then makes an addressed transmission to all other users within the target area (or volume). The transmission includes Device #1's device ID# and network address, and a request for a confirmation image of the recipient. After the confirmation images are received, the user then selects the image of the person (and the corresponding device ID# and network address) she is interested in. Further communication is addressed solely to the selected device.

One advantage of this method is that the user is not required to read a map on her device, trying to make an accurate correspondence between the person she is interested in and the corresponding symbol on her display. This is of particular value when the target individual is moving. Another advantage is that obstructions between the user and the target person are not an issue when targeting: a user may hold the device within a coat pocket or bag when targeting an individual. The only disadvantage in comparison with Method #8 is that the initial request for a confirmation image possibly may be made to more than one target device.

This method consists of the following steps:
(1) All devices periodically (at least once per second is recommended) determine their own position coordinates and broadcast those coordinates along with their device ID#'s to other devices in the immediate vicinity.
(2) User #1's device (Device #1) receives frequently updated location information from all other devices in its immediate vicinity.
(3) User #1 sees someone, User #2, to whom she wants to communicate. She aims her device (Device #1) at User #2. User #1 instructs her device via its user interface (she presses a button, for example) to contact all other devices in the direction of User #2 and obtain confirmation images of those users.
(4) User #1's device (Device #1) makes a transmission addressed to all devices in the target area as defined above. The transmission includes Device #1's device ID# and network address, as well as a request that confirmation images be sent to Device #1.
(5) Each device receiving the transmission responds with a transmission addressed to Device #1, sending its own device ID# and network address, as well as a confirmation image of its user.
(6) Device #1 receives confirmation images from all users in the target area.
(7) From the confirmation images received, User #1 selects the image corresponding to User #2, thereby selecting the device ID# and network address of User #2's device, Device #2.
(8) Device #1 initiates addressed communications with Device #2 and transmits an image of User #1. The means of transmission can be either direct (device to device, if the two devices are in the same general vicinity) or indirect (via a network to Device #2's network address).

Method #10: Addressing with Spatial Position

In this method, User #1 notices the person to which she wants to send a message, User #2, and with her device, Device #1, determines the precise distance and direction that User #2 is from her own position. This can be accomplished with any compass and distance measuring capabilities built into Device #1. Device #1 then transmits a message to a central server with instructions to forward the message to whatever device is at that specific position relative to her own position. The central server has access to absolute positions of all users and can easily calculate the absolute position indicated by adding the submitted relative position to Device #1's absolute position. The central server then determines what user is nearest to the calculated position and forwards the message to that user.

Method #11: Visual Biometric Addressing

This method generally involves capturing an image of some aspect of the target person, analyzing the image to produce a unique biometric profile, and then associating the biometric profile with an address. The image analysis can be performed on either (1) the user's device or (2) on a central server. In the first case, the user's device would send the message and biometric profile to the central server to be forwarded to the user associated with that biometric profile. The server has access to a user database which associates user's addresses, device ID#'s, and biometric profiles. The server would then associate the biometric profile with an address, and forward the message to that address. In the second case, the user's device would send the message along with the captured image to the server. The server would then analyze the image, match the resulting biometric profile to an address, and forward the message to that address.

There are several types of biometric profiles that this method could be applied to: facial recognition, outer (external) ear recognition, and retinal pattern, for example. Each type of biometric analysis would require a specialized camera for that purpose to be integrated into users' devices. However this invention is agnostic as to the specifics of what kind of biometric analysis is used, whether it is current or future biometric technology. The method of using a visually obtained biometric “signature” to address a message remains the same.

In all of the above variations, the user selects the intended target person by aiming the user's device at the target person and capturing an image.

Method #12: Auditory Biometric Addressing

This method involves using the distinct vocal characteristics of people both as a means of targeting a specific person, and also as a means of determining the target person's address. First, a voice sample needs to be collected. This can be done by the user moving close to the intended target and recording a voice sample when the target is speaking. Sound recording and editing features can easily be incorporated into small devices and this is existing technology. Alternatively, a directional microphone integrated into the user's device could be aimed at the target person for recording their speech. (It may be easier for a blind person to aim a microphone than to maneuver close to the target.)

After the voice sample is collected it can be analyzed either on the user's device or on a central server. If analyzed on the user's device, the. message along with the biometric profile can be sent to the server, where the biometric profile will be associated in a database with an address, and the message will then be forwarded to the target person. If the voice sample is analyzed on the central server, then the user's device sends the message along with the voice sample itself to the server. The server then converts the voice sample to a biometric profile, associates the profile with the address, and then forwards the message to that address.

Method #13: Addressing with a Visible Alphanumeric String

The most common examples of strings of alphanumeric characters displayed visibly and obviously associated with people are sports jerseys and license plates. Using this method, the alphanumeric string is associated with an address using a database either on a central server (in which case a user's device addresses a message to an alphanumeric string and sends the message to the server) or on the user's device (in which case a user has the ability to send a message directly to the target person's address).

There are two distinct ways that a user can select the target person: (a) the user can copy the alphanumeric string into her device, or (b) the user can capture the image of the alphanumeric string with a camera on her device. In the later case, optical character recognition (OCR) needs to be performed on the image to determine the alphanumeric string. OCR can be performed either on the user's device or on a central server. If it is performed on the user's device, then the all of the above options for associating the string with the address are available. If, however, OCR is to be performed on a central server, then the device must send the message along with the image of the alphanumeric string to the server, to be forwarded to the target person's device.

Methods #14 & #15: Data to Image Mapping

In contrast with some previous methods involving macroscopic images for the selection of the target person, Methods #14 and #15 do not depend on the user's device receiving images of other users from a central server or other users' devices. Instead, it is the user's own device which generates any necessary images of other users. In addition, in contrast with these previous methods, each image generated in Methods #14 and #15 by the user's own device may contain more than one person. Following is a description of the user's experience using these methods. Afterward, more technical descriptions will be given.

In order to use these methods, the user points the camera on her device at the person she would like to communicate with (see FIG. 1). She instructs her device (by pressing a button, for example) to either capture a still image, or to begin displaying live video. The camera generates an image of a person (or a group of people) from the user's point of view. The user views either a still image or a live video image on her device's display. Superimposed over the image of each person (only if that person is a user of the application) is a small graphic shape, a circle for example, which represents the location of that person's device. The user selects the person with whom she wants to communicate by tapping with a stylus the circle superimposed over that person's image. (Other user interfaces are compatible with this invention: for example, the user could select the desired circle by toggling from circle to circle by turning a dial on her device). Each circle is associated with the device ID# and network address of the device belonging to the user whose image lies underneath the circle. The user's device then initiates communication with the device of the selected person—either by sending a regular or Discreet message, or by initiating some other form of communication such as, for example, an instant messaging session, a telephone call, or a videophone call.

In order to achieve this operation, it must be possible to associate the device ID# and/or network address of a target person's device with the image of that person as represented on the display of a user's device. There are two alternative techniques for accomplishing this task: (1) mapping position data onto an image, and (2) focusing both light radiation from the target person and also data-carrying radiation from the target person's device onto the same imaging sensor (or two different imaging sensors and then overlay the data captured on each sensor).

Method #14: Data to Image Mapping—Mapping Position Data onto an Image

The means of associating a graphic symbol (a circle, for example) that is linked to data (device ID# and network address, for example) with a particular portion of an image (likeness of a target person, for example) is accomplished by mapping position data received from another person's device onto the display of the user's device. The process of mapping of objects that exist in 3-dimensional space onto the two-dimensional display of a user's device requires the following factors: (a) the position of the user's device, (b) the position of the target device(s), (c) the orientation of the user's device, (d) the focal length of the device's camera lens, (e) the size of the camera's image sensor, and (f) the pixel density of the sensor. The last three factors (d, e, and f) are properties of the user's camera and are either fixed quantities, or at least, in the case of the lens's focal length, known quantities easily output from the camera.

In order to acquire the position data, factors (a) and (b), an infrastructure is required (1) to determine the precise location of each device with location coordinates which are valid at least locally, and (2) to provide time-synchronization to all devices (at least locally) to sufficient accuracy (approximately 1/10 second accuracy is recommended for most situations). Time synchronization is necessary in order to take into account movement by either the user or potential target persons. If the location history of each device is stored for a trailing period of about 5-seconds (or similar period of time short enough so that only a manageable amount of memory is required, yet long enough so that all devices are able to respond to a request for information within that time period), then the locations of all users may be determined for the moment an image is captured.

Each device stores its own location data, or alternatively, the location data for all local devices is stored by a single third-party server. If a user targets a person by capturing a still image, then when the user presses a button to capture the image, his device broadcasts [to other devices within a specific domain, where “specific domain” can be defined in any one of a variety of ways, for example, (a) any user which receives the broadcast, (b) any user with location coordinates within a designated quadrant relative to the user, etc.] its own device ID and network address accompanied by a request for other devices to transmit their position coordinates for a specified moment within the past five seconds (or other pre-determined trailing period). When potential target devices receive this broadcasted request, they respond by transmitting to the network address of the requesting device (a) their device ID#, (b) their network address, and (c) their position coordinates for the time specified in the request. Alternatively, if the position data is stored on a third-party server, when the user captures an image, the request for position information is instead directed to the third-party server. The server then provides the requested position information of all eligible devices along with the associated device ID's and network addresses. The technology to accomplish both position and synchronization functions currently exists, and it is irrelevant to this invention which location and synchronization technologies are used as long as they deliver the required information.

Additionally, this technique requires that each device have the capability of accurately determining its own orientation in three-dimensional space, factor (c). Specifically, the information required is the orientation of the device's camera—horizontally (direction as it is projected onto a horizontal plane), vertically (the degree in which its orientation deviates from the horizontal), and “roll” (the degree to which the device is rotated about the axis defined by the direction that the device's camera is pointing). The technology for a device to determine its own orientation currently exists, and it is irrelevant to this invention which technology is employed as long as it delivers the required output. One adequate form of the required output describes the camera orientation with three angles: (φ, θ, ψ), where ψ is the degree that the camera is rotated to the left in a horizontal plane from a reference direction; θ is the degree that the camera is tilted up or down from the horizontal; and ψ is the degree that the camera is rotated in a clockwise direction about the axis defined by the direction it is pointing.

Following is a description of how the position of a target person's device may be mapped onto the display of a user's device.

FIG. 2 illustrates two users in 3-dimensional space described by an x,y,z coordinate system in which the z-dimension represents the vertical dimension and the x and y coordinates describe the user's location with respect to the horizontal plane. The locations of Device #1 and Device #2 are represented by the coordinates (x₁,y₁,z₁) and (x₂,y₂,z₂), respectively. (More precisely, the location coordinates represent the location of each device's image sensor.) User #1 points his device in the general direction of User #2 and captures an image at a particular moment in time, t. Simultaneously, his device broadcasts its own device ID and network address and a request to nearby devices to send their position coordinates at time t along with their device ID's and network addresses. User #2's device (Device #2, in User #2's bag) responds to this request by transmitting the requested position coordinates (x₂,y₂,z₂), device ID#, and network address to Device #1.

In order for Device #1 to represent on its display the location of Device #2 superimposed over the image of User #2, it must also have (in addition to the location coordinates of Device #2) its own location coordinates (x₁,y₁,z₁) and the orientation of its camera in space (φ, θ, ψ). These values are returned by the location system employed and the device orientation system employed, respectively.

FIG. 12 illustrates the same two users represented from an overhead viewpoint projected against the horizontal plane. The direction in which the camera is pointed in the horizontal plane is specified by a vector which is rotated φ degrees counterclockwise from the direction of the positive x-axis. In FIG. 13, the Z-axis represents the vertical dimension, and the horizontal axis represents the vector from Device #1 to Device #2 projected onto the x-y plane. The degree to which the camera orientation deviates from the horizontal is represented by the angle, θ. FIG. 14 illustrates the display of Device #1. The camera has been rotated ψ degrees in a clockwise direction about the axis defined by the direction the camera is pointing. This results in the rotation of the image in the display ψ degrees in a counterclockwise direction.

In the device display in FIG. 14 is shown the image of User #2 as well as a circle (or other geometric object) indicating the location of User #2's device. The position coordinates, x₁ and y₁ (given in units of pixels from the center point of the display), specify the placement of the circle in the display and are determined as follows.

$${x}_{p} = - {y}_{0}^{′} ( \frac{{P}_{H}}{{S}_{x}} ) ( \frac{{x}_{0}^{′} - \sqrt{{x}_{0}^{′2} - 4 {x}_{0}^{′2} f}}{{x}_{0}^{′} + \sqrt{{x}_{0}^{′2} - 4 {x}_{0}^{′2} f}} )$$

$$and$$

$${y}_{p} = {z}_{0}^{′} ( \frac{{P}_{V}}{{S}_{y}} ) ( \frac{{x}_{0}^{′} - \sqrt{{x}_{0}^{′2} - 4 {x}_{0}^{′2} f}}{{x}_{0}^{′} + \sqrt{{x}_{0}^{′2} - 4 {x}_{0}^{′2} f}} )$$

where

P_{H}=total number of horizontal pixels on the image sensor

P_{V}=total number of vertical pixels on the image sensor

Sₓ=width of the image sensor

S_{y}=height of the image sensor

f=focal length of the camera lens

and

x₀=cos θ(x₀ cos+y₀ sin φ)+z₀ sin θ

y₀=cos ψ(−x₀ sin φ+y₀ cos φ)+sin ψ[z₀ cos θ−(x₀ cos φ+y₀ sin φ)sin θ]

z₀=−sin ψ(−x₀ sin φ+y₀ cos φ)+cos ψ[z₀ cos θ−(x₀ cos φ+y₀ sin φ)sin θ]

where

x₀=x₂−x₁

y₀=y₂−y₁

z₀=z₂−z₁

Note that a simpler version of this technique is possible which uses 2-dimensional rather than 3-dimensional position analysis. In this simpler version, the user's device does not have information as to the elevation of the other user's device. It only knows its location in the horizontal plane. Thus, instead of a geometric shape appearing on the user's display at a point which corresponds to the point that the other user's device would appear if it was visible, a narrow vertical bar appears on the display which intersects the same point. The system is the same in all other respects. This simpler level of complexity comes at little cost. The only situation that would confound a 2-dimensional system is when two potential targets are in the same horizontal direction from the user's perspective, but one target is directly above or below the other.

Method #15: Data to Image Mapping—Focusing Data Signals onto an Image Sensor

This method is the same as Method #14 with the exception that it uses a different technique for associating a graphic symbol (a circle, for example), which is linked to data (Device ID and network address, for example), with a particular portion of an image (likeness of a target person, for example). The technique used here is that each device broadcasts a signal which is directional and has a limited ability to penetrate solid objects (clothing, for example)—the best frequencies being in the gigahertz to sub-infrared range. The lens of the camera focuses this data-carrying radiation together with the visible light-frequency radiation onto the same image sensor. [There are several lens materials that have the same index of refraction for both light radiation and other wavelengths in the range under discussion.] Intermingled with elements of the image sensor which are sensitive to light radiation are other elements which are sensitive to the data-transmitting wavelengths. These other elements are able to receive and decode data and also tag each signal with the place on the sensor in which it is received.

Because it is not important to determine shape from incoming sub-infrared radiation, but merely position, lower resolution, and hence lower pixel density is required for elements that are sensitive to these data-transmitting wavelengths. However, each of these elements in the image sensor is required to be able to receive and channel data from independent data streams as there may be more than one device “appearing” on the sensor which is transmitting its data. Each data stream is indexed and stored with the pixel number which receives the data. Because the data to be transmitted is very small - one device ID or network address—the time of transmission from the onset of the signal to the end of the signal is too short to result in any significant “blurring” across pixels.

A variation of this method is to focus the light radiation and the data-transmitting radiation onto two separate sensors. Using this variation it is necessary to associate the relative positions on each of the sensors so that for any given pixel on the data sensor, the corresponding location on the image sensor can be calculated, and thus a geometric shape can be displayed at that position superimposed over the image.]

Method #16

This method is similar to Method #1 with one important difference: Instead of a user's device (Device #1) receiving images of other users in recognition proximity from their devices, only device ID's and/or network addresses are received from other users' devices. The images of those other users are received from a data processing system.

There are two main variations of this method. In the first variation, Device #1 broadcasts a request for device ID's and/or network address with a signal strength sufficient to reach all devices within recognition proximity. If this request includes Device #1's device ID and/or network address, then the devices receiving this request may either send the requested information in an addressed transmission to Device #1, or alternatively, devices may respond by simply broadcasting the requested information.

In the second variation, all devices constantly, or intermittently (for example, once per second), broadcast their device ID and/or network address with signal strength necessary to reach other devices within recognition proximity. Device #1 would then obtain the device ID's and/or network addresses of other devices in recognition proximity simply by “listening”.

The device ID's and/or network addresses obtained by Device #1 are then transmitted to a data processing system with a request for an image(s) of each of the associated users. The data processing system then transmits to Device #1 the requested images paired with their respective device ID's and/or network addresses. The user of Device #1 (User #1) views the images received and selects the image which corresponds to the intended target person (User #2), thus selecting Device #2's device ID and/or network address.

Device #1 then initiates addressed communication with Device #2. The means of transmission can be either direct (device to device, if the two devices are in the same general vicinity) or indirect (via a network to Device #2's network address). The communication may or may not be mediated by a data processing system.

Method #17

This method is roughly a combination of Method #16 and Method #5. The only way in which this method differs from Method #16 is the manner in which the user's device (Device #1) obtains the device ID's and network addresses of other devices in “recognition proximity” of the user (User #1). In this method the ID/addresses are obtained from RFID tags (active or passive) that represent other user's devices and that may or may not be physically incorporated within the devices they represent. In order to obtain other devices' device ID's and network addresses, Device #1 transmits a non-directional signal interrogating all RFID tags within recognition proximity of User #1. In response to this interrogation, all RFID tags transmit (broadcast) the device ID and/or network address of the devices they represent. Device #1 thus receives the RFID transmissions carrying the device ID and/or network addresses of all devices in recognition proximity. From this point on, Method #17 is identical with Method #16.

IV. Messaging System

One of the purposes of this system is to allow users to communicate electronically with other users in their immediate environment even though no contact information is known about those individuals. A second purpose of the system is to provide the powerful tool of Discreet Messaging which allows users to express interest in other users while at the same time (a) minimizing the risk of rejection and (b) minimizing unwanted advances. Discreet Messaging can also be helpful in providing the basis for initial conversation and establishing personal connections.

Electronic. Non-Conditional Messaging

The means is provided of sending a message from one device to another device with no conditions attached. Messages are sent to specific individuals using the methods outlined above. When the intended receiver's device receives the message, the receiving device sends a confirmation signal to the sending device which assures the user that the message has been successfully delivered. Reasons that a message would not be delivered are: the receiver's device is turned off; they are out of physical range of either the user's device or any network; the receiver has chosen not to accept non-DM's; or the receiver has blocked that particular sender from sending messages to that recipient. If the intended recipient is out of direct transmission range, messages will be transmitted via the internet.

The content of the message can be one of several “pre-packaged” text, audio, image, or video messages such as “I'd like to meet”, or a custom made message—either text, audio, image, or video—created by the user and used as needed. Alternatively, a new message can be created for each occasion or each recipient. To create a custom message, the user inputs the content of the message into the device using any method currently in existence, or yet to be invented, for example, writing on the display of the device while the system's handwriting recognition system, similar to the Palm system, digitizes the input; or speaking into the device's microphone while the system digitizes the audio input as audio, or converts it to written form; or recording one or more frames of video using the device's camera; or a combination of the above.

Addressing a message, from the user's point of view, consists of using one of the methods outlined above under the section “Perceptual Addressing”. When the user is presented with one or more confirmation images of other users in order to confirm the correct recipient, the user merely selects the image of choice (using any effective means of selection, for example, tapping on the image with a stylus), and then instructing the device to send the message (using for example, by pressing a button labeled “send non-DM”). The message is either transmitted directly to the other device, or transmitted via a network, depending on the proximity to the other device.

### Discreet Messaging

Unlike regular messaging, a recipient of a Discreet Message (DM) is not permitted to read a message received, or (in this specific version of DM) even permitted to have any indication that a message has been received, unless the recipient meets certain necessary conditions.

(Other implementations of DM may include an additional user variable called level of notification which, in contrast with the above, the sender may have the option of allowing the recipient to know more than merely the fact that a DM was received. The sender may select which additional pieces of information may be included in the notification. For example, the sender may choose one or more of the following pieces of information to be included in the notification that a DM was received: (a) date and time DM was received, (b) location of sender when DM was sent, (c) mutual friends or acquaintances with the sender, (d) first name of the sender, or (e) custom message written by the sender which is not subject to the contingencies of a DM.)

Discreet Messaging can be implemented in one of two ways: (1) using a third-party server to mediate the transmission of information between users' devices, or (2) a peer-to-peer solution in which each user's device in association with another user's device acts as the “trusted third party” in mediating the revealing of information to the users. Whichever method is used, the logic of Discreet Messaging remains the same and is described as follows.

Necessary Conditions

In this particular example of Discreet Messaging, the first condition to be met for a DM to be viewable is: (a) the recipient (User #2) of a DM (sent by User #1) must also independently send a DM to the original sender (User #1) either before or after User #1 sends a DM to User #2. As an enhancement to Discreet Messaging, it is possible to incorporate profile matching technology (employed by various internet web sites and cellular telephone dating services) as an additional condition for a Discreet Message to be viewable. If profile matching is incorporated, then, in this particular example of Discreet Messaging, there are two additional conditions placed upon whether or not a DM is viewable: (b) that User #2 have certain personal attributes (stored on his device as “Personal Data”) that meet a set of criteria (“Match Criteria”) specified by User #1, and (c) that User #1's Personal Data meets the Match Criteria of User #2. Condition (a) ensures that the recipient will not see or be aware of a message at all (even though his or her device receives a transmission) unless he or she independently sends a DM to the original sender indicating some level of interest. Conditions (b) and (c) ensure that a recipient will not be aware that a message has been sent unless both users meet minimal requirements for mutual compatibility.

In comparing the Match Criteria of one user with the Personal Data of the other user, it must be possible to “match up” each condition specified by one user with the appropriate content from another user. This matching can be done by having the same standard categories for information about the user as there are for the selection criteria on that content. In this application, conditions placed by User #1 on the Personal Data of User #2 are specified in User #1's Match Criteria. The Match Criteria is then compared to the Personal Data, category by category. Users may enter their Personal Data and Match Criteria into their device in response to a menu-prompted multiple-choice questionnaire. Their responses are then stored and applied to all Discreet Messages sent and received.

The Personal Data of one user may meet the Match Criteria of another user to different degrees - anywhere from all categories matching to no categories matching, in this particular example of a dating application, 100% matching is required. Therefore, only if all categories of Personal Data meet the criteria specified in all categories of the Match Criteria, does User #2 meet User #1's Match Criteria. This requirement, however, is much less stringent than it may seem because for any particular category in a user's Match Criteria, the user may specify several acceptable “answers” or even “no preference”. In the extreme, a user may select “no preference” for all categories, which would effectively be a “null” Match Criteria, resulting in a match with any set of Personal Data.

Viewable Message—Non-Variable

If all of the conditions above are satisfied, then both users will be notified that they have received a DM from the other. What will actually be viewed by the recipient, say User #1, of a DM is:
a message from the other user, User #2, which consists of some combination of text, image, audio, or video. This may be a default message which is prepared in advance, or a message prepared specifically for this DM. There are no restrictions on the content of this message, and it can be extensive or very brief.
an image of User #2's face—or if User #2 is in a vehicle, the license plate number vehicle, image of the license plate, or image of the vehicle. (There really is no restriction on the content of the image, except that it fulfills its purpose of identification and confirmation: this enables someone sending a message to this user to match the image to the visual appearance of the user.)
the current location of User #2 indicated on a two-dimensional map on the device display, and direction of User #2 from User #1's position. This information is available only if either Method 6 or Method 7 of Perceptual Addressing is used in which location coordinates and directional orientation of devices are determined—and only if the other user is in the immediate vicinity.
User #2's preferred mode of being contacted (in person, via telephone, via email, etc.) and relevant contact information of User #2 (telephone number, email address, etc.).

Viewable Message—Variable

In addition to the above message content, there is other viewable message content which is variable in the sense that the viewable content of the message received by User #1 from User #2 depends upon the content of the message sent from User #1 to User #2. The nature of the dependency, however, can vary, the only restriction being that the possibility of circularity must be avoided. In this example of Discreet Messaging, there are four varieties of variable content, each with its own kind of dependency:
Commonalities
   As part of the set-up process, users input information about themselves into their device in several predetermined categories, such as their date of birth, place of birth, religion, political affiliation, etc. If the Necessary Conditions are met for each user to view a DM from the other, then all of the Commonality Data is transmitted from each user's device to the other user's device. This information, however, is not accessible to the other user. Then on each user's device, the data of the two users is compared, category by category. For each category, if the data of both users is similar or identical, then that data will be viewed as part of the DM received from the other user. If the data is not the same, then it will not be viewable. For example, if User #1 is Catholic, a Democrat, born in Duluth, Minn., USA, and has two cats; and User #2 is Jewish, a Democrat, born in Minneapolis, Minn., USA, and has a dog; then included in the DM sent to both users is the message that the other user is a Democrat from Minnesota, USA. No mention is made of their religion or pets. The preferred method is for users to enter data by means of a questionnaire in which they choose their answers from a list of options. Alternatively, users could input their data as free-form text in answer to a menu of questions, one question per category of data. Then users' data would be compared, category by category, using a fuzzy logic algorithm to decide if an answer given by one user is the same as the answer given by the other user.
Intersecting Social Circles
   There are two levels of reporting to each user the social connections they share with the other user. The first method is advantageous in that it does not require the use of an external database, but it provides less information than the second method in which both devices access a database via their wireless connection to a network.
   Intersecting Social Circles Method #1
   As part of the set-up process, users input the names of all of their friends, family, and acquaintances into their devices. If the Necessary Conditions are met for each user to view a DM from the other, then all of the names of the people in each user's social circle are transmitted from each user's device to the other user's device. This information, however, is not accessible to the other user. Then on each user's device, the list of names associated with each user is compared. If a name on the list of both users is similar or identical, then that name will be viewed as part of the DM received from the other user. If a name is not the same, then it will not be viewable. The determination of whether two names are the same can be problematic due to the use of nicknames, initials, etc. For this reason, a fuzzy logic algorithm is employed. Errors can be made not only in the vein of false positives and false negatives in the determination of whether two names are the same (is “Jack Smith” the same name as “John Smith”?), but also errors can be made because two different people have the same name. In either case, errors are not a significant problem in that a major purpose of this application is to provide a basis for conversation, and determining that “John Smith” is actually two different people can be a useful conversation for “breaking the ice”.
   Intersecting Social Circles Method #2
   As part of the set-up process, users input the names of all of their friends, family, and acquaintances into their devices or into a computer. This information is transmitted over a network to a database on a computer which stores the social circle of each user and also integrates the social circles of many users to build a social network model of all users. If the Necessary Conditions are met for each user to view a DM from the other, then the social network database is accessed by each user. Each device reports the User ID#'s of both users to the database, which in turn determines the relationships between the two users in terms of the social links between them. These sequences of links are then transmitted over the network back to both users' devices. This relationship between users is then shown in a graphical form on users' device displays. This relationship, however, can only be determined if the social network database is complete enough. If the relationship between users cannot be determined, then this information will not be included in the DM.
   Level of Interest
   Each user will input into his or her own device the Level of Interest they have in the other user. This information will be transmitted to the other user's device. But the degree of interest of User #1 in User #2 which is actually displayed to User #2 is contingent not only on the degree of interest in User #2 expressed by User #1, but also on the degree of interest in User #1 expressed by User #2. The degree interest actually displayed to both parties is always the same: the lowest common degree of interest expressed by either user. For example, if User #1 is “infatuated” with User #2, but User #1 is only “interested” in User #I, then User #2 views User #1's degree of interest as “interested”. Rather than enter this information every time a message is to be sent, the user can choose a default level of interest (e.g. “interested”) but for any given situation may select a different level of interest. The user may choose from the following levels of interest:
      a) interested
      b) attracted
      c) captivated
      d) infatuated
      e) in love

[A variation of Discreet Messaging is that the sender (User #1) of a DM can specify, either as a default or for each specific DM sent, that the receiver (User #2) of a DM will receive a notification that an anonymous DM has been received even if the receiver (User #2) has not sent a DM to the original sender (User #1). (User #2 is not at this point able to view the DM.) The reason that users may not opt for anonymous notification is that it is possible that the timing and circumstances of a notification that a DM has been received will give clues as to the identity of the sender, and thus serve to increase the risk of rejection or embarrassment that the sender assumes.]

With Discreet Messaging it is important that users feel confident that DM's sent will absolutely not be revealed unless the interest is mutually expressed. For this reason two additional features are included in this system. First, DM's are assigned an expiration date either by default, or manually by the user for each DM sent. When a DM expires it is deleted on the user's device, and also, depending on the implementation of discrete Messaging, it is deleted on the third-party database or recipient's device. Second, user's have the ability to transmit a deletion command which causes the immediate deletion of any unexpired DM's that were previously sent by the user and now reside in a third-party database or on other users' devices. [A related security feature is user's (User #1) ability to send a deletion transmission to any other user (User #2) which causes the deletion of the user's (User #1) photo and associated device ID# and network address on the recipient's (User #2) device. At the same time, all of User #2's information would be deleted on User #1's device. (described below in the “Security” section)]

Content of Outgoing Transmissions
Sending a Discreet Message may actually consist of several interactive exchanges of information among devices, involving several transmissions. (Note: This will depend somewhat on whether a third-party server or a peer-to-peer system is implemented. This description is meant primarily for the peer-to-peer system.) In this example of a dating application, the information transmitted in Part 1 of a DM includes the following:
(1) device ID#
(2) network address
(3) location data
(4) flag that “this is a DM”
(5) expiration date of the DM
(6) image of user
(7) user's Match Criteria

If both parties meet all conditions, then the following is also transmitted in Part 2 of a DM:
(8) preferred method of contact and contact information
(9) personal data from which commonality is determined
(9) social circle intersection: list of names in social circle if Method #1 is used. If Method #2 is used, no further information need be transmitted.
(9) Level of Interest
(10) text message, image, audio, or video clip

Operation and Flow of Information in Discreet Messaging

These descriptions of Discreet Messaging ignore the technicalities of Perceptual Addressing and the various methods of transmission (which are described above), and instead focus only on the mechanics of Discreet Messaging.

Third-Party Server Solution

FIG. 15, which depicts tasks 1501 through 1514, describes in general the logical operation and flow of information among the devices of two users who send Discreet Messages to each other, together with an intermediate server and database. As stated earlier, electronic communication systems mediated by third-party servers are currently implemented for users whose email addresses or telephone numbers are already known by the senders. However, the combination of this capability of automated third-party mediated communications with Perceptual Addressing produces a powerful social communications tool because it allows mediated communications to be conducted with strangers in one's immediate environment.

Supplemental details about some of the depicted tasks are disclosed here. At task 1502, the Discreet Message includes the following information:
sender's device ID# and network address
recipient's device ID# and network address
the level of notification of the receiver
image of sender
the content of the message
the contingencies for the delivery of different aspects of the message
contact preferences and contact information
spatial coordinates and distance from User#2 (if available with Spatial Addressing method used)

At task 1508, depending on the level of notification specification of the Discreet Message, this indication may only be a message indicating that a Discreet Message was received. Other types of indication may reveal more information such as the name of a mutual acquaintance, or the approximate location of the sender, etc.

At task 1512, the Discreet Message is forwarded subject to the contingencies for delivery of different aspects of the message, such as level of interest.

In a message flow that is alternative to what is depicted in FIG. 15, “Device #1” and “User #1” can be interchanged with “Device #2” and “User #2,” respectively.

Peer-to-Peer Solution

FIGS. 16 through 18 describe an example of the logical operation and flow of information of Discreet Messaging from the point of view of a single device (i.e., Device #1). For a 2-device system, see the following step-by-step description of the operation and flow of information in this particular application of the Discreet Messaging process. It is assumed, in this description, that the method of Perceptual Addressing used is Method #8: Location Identification & Spatial Mapping. At task 1601 in FIG. 16A, User #1 sees someone (User #2) that he is interested in. He targets her on his device (Device #1). He looks at his device's display which shows a map of users (including himself) in recognition proximity, each represented by a small symbol. He selects a symbol that he believes corresponds to User #2. Device #1 sends a transmission to the Device ID# associated with the symbol selected. The transmission includes: (i) Device #1's Device ID# and network address, and (ii) request for image of User #2.

User #2's device (Device #2) receives the request and transmits an image of User #2 to Device #1.

At task 1602, Device #1: (a) receives the image of User #2, and (b) stores the image of User #2 along with Device #2's Device ID# and network address. User #1 views the image of User #2 on the display of his device and confirms that the image does indeed represent the person he intended to contact. Because User #1 has already prepared a default text message (which simply says “Hi, my name is David. Would you like to meet?”), and has set as a default that the recipient must satisfy his Match Criteria which he has also previously prepared, he does not need to prepare anything more.

At task 1603, User #1 pushes a button labeled “send DM”. Before sending the DM, Device #1 confirms that there is no record of a mutual mismatch between User #1 and User #2 created within the past week. (This is a security measure to prevent users from making systematic probes to determine the content of another user's Personal Data.) If there is a stored record of a mutual mismatch, task execution proceeds to task 1604. If there is not a stored record of a mutual mismatch, task execution proceeds to task 1606.

At task 1604, Device #1 provides a User Alert: “Recent mutual mismatch with User #2—DM not sent.” At task 1605, Device #1 does not send the DM to User #2, and Device #1 deletes User #2's image. Task execution then ends.

At task 1606 in FIG. 16B, Device #1 sends Part 1 of a DM to User #2 containing: (i) flag that this is a DM; (ii) date and time sent; (iii) the expiration date and time of this DM, derived from the default lifetime of a DM previously set by User #1 added to the sending date/time. (User #1 could have chosen to customize the lifetime of the DM); and (iv) User #1's Match Criteria.

Device #2 receives User #1's DM, but does NOT alert the user that a message has been received. Device #2 transmits a signal to Device #1 confirming receipt of the DM. Device #2 stores a record of the DM received including: (i) the date and time the DM was received, (ii) the expiration date and time of the DM, (iii) Device #1's Device ID# and network address, and (iv) User #1's Match Criteria. Device #2 checks its memory to see if there is an unexpired DM that it had previously sent to User #1 and has yet to expire, and finds there is not. (The case, in which there is an unexpired record in memory of a DM previously sent to the same party from which a DM is just received, is explored from User #1's point of view, beginning at task 1701.)

At task 1607, Device #1 checks if it has received confirmation of receipt from User #2. If so, task execution proceeds to task 1612. If not, task execution proceeds to task 1608.

At task 1608, Device #1 checks if the DM has been sent more than 5 times. If so, task execution proceeds to task 1610. If not, task execution proceeds to task 1609.

At task 1609, a progressively longer delay is imposed on Device #1 before proceeding to task 1606. Task execution then proceeds to task 1606.

At task 1610, Device #1 provides a User Alert: “DM to User #2 undeliverable.” Also, Device #1 deletes the stored record of the DM that was intended for User #2.

At task 1611, Device #1 deletes User #2's photo. (No information identifying the recipient is retained.) Task execution then ends.

At task 1612, Device #1 displays an image of User #2 and a message that the DM was successfully sent.

At task 1613, Device #1 stores a record of the DM sent to User #2, including: (i) the date and time the DM was sent, (ii) the expiration date and time of the DM, (iii) Device #2's Device ID# and network address, (iv) Match Criteria sent to User #2, and (v) image of User #2.

At task 1614, Device #1 checks its memory to see if there is an unexpired DM that has been received from User #2. If there is, task execution proceeds to task 1617. If there is not, task execution proceeds to task 1615.

At task 1615, Device #1 holds the record of the DM sent to User #2 until it expires. This can occur as the result of User #2 never having sent a DM to User #1.

At task 1616, when the DM expires, Device #1 provides a User Alert: “DM sent to User #2 has expired.” Device #1 records in a log of DM's sent: (a) date sent, and (b) expired. User #1's DM that was sent to User #2 and stored on both Device #1 and Device #2 is deleted. (User #2 never knows that User #1 sent a DM to her.) Task execution then proceeds to task 1611.

At task 1617, Device #1 retrieves from memory the record of the DM from User #2. Task execution then proceeds to task 1801.

As a first alternative, it is possible that User #2 sends a DM to User #1 after User #1's DM to User #2 has expired, as checked at task 1614. The result is the same as described in tasks 1615 and 1616 with the exception that after the deletion of records and creation of log entries described above, a new DM is initiated by User #2. The sequence of events that follows is accurately described beginning with task 1601 above, with the exception that the names “User #1” and “User #2” are interchanged.

As a second alternative, User #2 sends a DM to User #1 before User #1's DM to User #2 expires. In this alternative, User #2 sees User #1 and is interested in him. She targets him on her device (Device #2): (a) she looks at her device's display which shows a map of users (including herself) in recognition proximity, each represented by a small symbol, and (b) she selects a symbol that she believes corresponds to User #1. Device #2 sends a transmission to the Device ID# associated with the symbol selected. The transmission includes: (a) Device #2's Device ID# and network address, and (b) a request for image of User #1.

Device #1 receives the request and transmits an image of User #1 to Device #2.

Device #2: (a) receives the image of User #1, and (b) stores the image of User #1 along with Device #1's Device ID# and network address.

User #2 views the image of User #1 on the display of her device and confirms that the image does indeed represent the person she intended to contact. Because User #2 has already prepared a default text message (which simply says “Hi, my name is Michelle. I wondered if you might be interested in meeting sometime?”) and has set as a default that the recipient must satisfy her Match Criteria which she has also previously prepared, she does not need to prepare anything more. She pushes a button labeled “send DM”. Before sending the DM, Device #2 confirms that there is no record of a mutual mismatch between User #2 and User #1 created within the past week.

Device #2 sends Part 1 of a DM to User #1 which contains the same type of data as User #1's message to User #2: (i) flag that this is a DM, (ii) date and time sent, (iii) the expiration date and time of this DM, and (iv) User #2's Match Criteria.

At task 1701 depicted in FIG. 17, Device #1 receives User #2's DM, but does NOT alert User #1 that a message has been received.

At task 1702, Device #1 transmits a signal to Device #2 confirming receipt of the DM.

At task 1703, Device #1 stores a record of the DM received including: (i) the date and time the DM was received, (ii) the expiration date and time of the DM, (iii) Device #2's Device ID# and network address, and (iv) User #1's Match Criteria.

At task 1704, Device #1 checks in memory to see if there is an unexpired DM that it had previously sent to User #2. If so, task execution proceeds to task 1801. If not, task execution proceeds to task 1705.

At task 1705, Device #1 holds the record of the DM sent to User #2 until it expires.

At task 1706, when the DM expires, Device #1 deletes the expired record of DM from User #2. Task execution then ends.

Meanwhile, Device #2: (a) receives the confirmation signal that Device #1 received Device #2's DM; (b) displays an image of User #1, and a message that the DM was successfully sent; and (c) stores a record of the DM sent to User #1, including: (i) date and time the message was sent, (ii) expiration date and time of the message, (iii) Device #2's Device ID# and network address, (iv) Match Criteria sent to User #1, and (v) image of User #1. Device #2 also: (d) checks its memory to see if there is an unexpired DM that has been received from User #1, and finds that there is; and (e) compares User #1's Match Criteria with User #2's Personal Data, category by category, and determines whether or not User #2 meets User #1's match criteria.

FIG. 18 depicts four possible outcomes that are associated with determining whether the personal data of each user meet the match criteria of the other user. The first outcome is that User #1 does not meet User #2's Match Criteria, but User #2 does meet User #1's Match Criteria. The second outcome is that User #2 does not meet User #1's Match Criteria, but User #1 does meet User #2's Match Criteria. The third outcome is that neither user meets the Match Criteria of the other. The fourth outcome is that both users meet the Match Criteria of the other.

At task 1801 depicted in FIG. 18, Device #1 compares User #2's Match Criteria with User #1's Personal Data, category by category.

At task 1802, Device #1 determines whether or not User #1 meets User #2's match criteria. If so, task execution proceeds to task 1803. If not, task execution proceeds to task 1810.

At task 1803, Device #1 sends a message to Device #2 that User #1's Personal Data meets User #2's Match Criteria. The message also indicates whether or not User #2's Personal Data meets User #1's Match Criteria.

Device #2 performs the following tasks if User #2 does not meet User #1's Match Criteria. When Device #2 receives the message sent at task 1803, Device #2: (a) alerts User #2 with a vibration or auditory signal. Device #2 displays an image of User #1, and a message that the DM User #2 sent to User #1 resulted in a mismatch and was not viewed. (NOTE: User #2 is not aware if the mismatch was a result of her data not meeting User #1's Match Criteria, or if it was the result of User #1's Personal Data not meeting her Match Criteria.) Device #2 then (a) sends a message to Device #1 that User #2's Personal Data does not meet User #1's Match Criteria; (b) stores a record of the mutual mismatch with User #1 for one week; and (c) deletes the image of User #1, deletes the record stored in memory of the DM sent to User #1, and deletes the record of the DM received from User #1.

At task 1804, if User #2's personal data meet User #1's match criteria, task execution proceeds to task 1805. If not, task execution proceeds to task 1811.

At task 1805, Device #1 sends Part 2 of User #1's DM to User #2: (i) User #1's name or alias, (ii) User #1's spatial coordinates and distance from User #2 (if spatial coordinates are available with the method of Perceptual Addressing used, and also if User #1 is in the same vicinity as User #2), (iii) User #1's contact preferences and contact information, (iv) text, audio, image, or video message, and (v) User #1's Level of Interest in User #2.

At task 1806, Device #1 compares User #1's Level of Interest in User #2 with User #2's Level of Interest in User #1, and sets the “Mutual Level of Interest” equal to the lower of the two levels.

At task 1807, Device #1 alerts User #1 that a DM has been received with a signal (vibration or auditory tone, for example). Device #1 displays: (i) image of User #2; (ii) User #2's name or alias; (iii) User #2's contact preferences and contact information; (iv) Mutual Level of Interest; (v) message (text or audio, for example) from User #2; (vi) distance from User #1 (if spatial coordinates are available with the method of Perceptual Addressing used, and also if User #2 is in the same vicinity as User #1); and (vii) map identifying relative positions of Users #1 and #2 (if spatial coordinates are available with the method of Perceptual Addressing used, and also if User #2 is in the same vicinity as User #1).

At task 1808, Device #1 stores in “Address Book”: (i) User #2's name or alias; (ii) image of User #2; (iii) User #2's contact preferences and contact information; (iv) Mutual Level of Interest; (v) message (text or audio, for example) from User #2; (vi) date/time DM received; and (vii) Device ID# and network address of User #2 (hidden data).

At task 1809, Device #1 deletes the record stored in memory of the DM sent to User #2, and deletes the record of the DM received from User #2. Task execution then ends.

At task 1810, Device #1 sends a message to Device #2 that User #1's Personal Data does not meet User #2's Match Criteria.

When Device #2 receives the message sent at task 1810, Device #2: (a) alerts User #1 with a vibration or auditory signal, and (b) displays an image of User #1, and a message that the DM User #2 sent to User #1 resulted in a mismatch and was not viewed. (NOTE: User #2 is not aware if the mismatch was a result of her data not meeting User #1's Match Criteria, or if it was the result of User #1's Personal Data not meeting her Match Criteria.) Device #2 also: (c) sends a message to Device #1 that User #2's Personal Data does not meet User #1's Match Criteria; (d) stores a record of the mutual mismatch with User #1 for one week; and (e) deletes the image of User #1, deletes the record stored in memory of the DM sent to User #1, and deletes the record of the DM received from User #1.

If neither user meets the Match Criteria of the other, (a) Device #1 ignores messages from Device #2 that User #2's Personal Data meets User #1's Match Criteria, and (b) Device #2 ignores messages from Device #1 that User #1's Personal Data meets User #2's Match Criteria.

At task 1811, Device #1 stores a record of the mutual mismatch with User #2 for one week.

At task 1812, Device #1: (a) alerts User #1 with a vibration or auditory signal; and (b) displays an image of User #2 and a message that the DM User #1 sent to User #2 resulted in a mismatch and was not viewed. (NOTE: User #1 is not aware if the mismatch was a result of his data not meeting User #2's Match Criteria, or if it was the result of User #2's Personal Data not meeting his Match Criteria.)

At task 1813, Device #1 deletes the image of User #2. Task execution then proceeds to task 1809.

During the execution of tasks 1810 through 1813, Device #1 might have received a message from Device #2 that User #2's Personal Data meets User #1's Match Criteria. If so, Device #1 ignores the message from Device #2 that User #2's Personal Data meets User #1's Match Criteria.

When Device #2 receives the transmission from User #1 that User #1's Personal Data does not meet User #2's. Match Criteria (transmitted at task 1810), Device #2 alerts User #2 with a vibration or auditory signal. Device #2 also displays an image of User #1, and a message that the DM User #2 sent to User #1 resulted in a mismatch and was not viewed. (NOTE: User #2 is not aware if the mismatch was a result of her data not meeting User #1's Match Criteria, or if it was the result of User #1's Personal Data not meeting her Match Criteria.) Device #2 stores a record of the mutual mismatch with User #1 for one week. Lastly, Device #2 deletes the image of User #1, deletes the record stored in memory of the DM sent to User #1, and deletes the record of the DM received from User #1.

Task 1814 represents how Device #1 reacts when Device #2 determines whether or not User #2's Personal Data meets User #1's Match Criteria. At task 1814, Device #1 receives a transmission from User #2 that indicates the result of comparison between User #1's Match Criteria and User #2's Personal Data. Task execution then proceeds to task 1804.

In the situation where it is determined that User #2's Personal Data does not meet User #1's Match Criteria, Device #2 ignores messages from Device #1 that User #1's Personal Data meets User #2's Match Criteria.

In the situation where it is determined that User #2's Personal Data does, in fact, meet User #1's Match Criteria, Device #2 might receive a message from Device #1 that User #1's Personal Data meets User #2's Match Criteria (as transmitted by Device #1 at task 1803). In addition, Device #2 sends Part 2 of User #2's DM to User #1, which includes: (i) User #2's name or alias; (ii) User #2's spatial coordinates and distance from User #1 (if spatial coordinates are available with the method of Perceptual Addressing used, and also if User #2 is in the same vicinity as User #1); (iii) User #2's contact preferences and contact information; (iv) text, audio, image, or video message; and (v) User #2's Level of Interest in User #1. Device #1's receiving of this message is represented by task 1815.

At task 1815, Device #1 receives Part 2 of User #2's DM to User #1. Task execution then proceeds to task 1806.

Meanwhile, Device #2 receives Part 2 of User #1's DM to User #2 (as transmitted by Device #1 at task 1805). Device #2 compares User #2's Level of Interest in User #1 with User #1's Level of Interest in User #2, and sets the “Mutual Level of Interest” equal to the lower of the two levels. Device #2 then (a) alerts User #2 that a DM has been received with a signal (vibration or auditory tone, for example) and (b) displays: (i) image of User #1; (ii) User #1's name or alias; (iii) User #1's contact preferences and contact information; (iv) Mutual Level of Interest; (v) message (text or audio, for example) from User #1; (vi) distance from User #2 (if spatial coordinates are available with the method of Perceptual Addressing used, and also if User #1 is in the same vicinity as User #2); and (vii) map identifying relative positions of Users #1 and #2 (if spatial coordinates are available with the method of Perceptual Addressing used, and also if User #1 is in the same vicinity as User #2).

Device #2 then stores in “Address Book”: (i) User #1's name or alias; (ii) image of User #1; (iii) User #1's contact preferences and contact information; (iv) Mutual Level of Interest; (v) message (text or audio, for example) from User #1; (vi) date/time DM received; and (vii) Device ID# and network address of User #1 (hidden data). Device #2 also deletes the stored records of: (i) DM sent to User #1, and (ii) DM received from User #1.

V. Security
A user has the ability to ban all future communications from any particular user. This consists of a permanent non-response to all transmissions from that user's device.
Users don't have direct access to device ID#'s or network addresses of other users. They address communications to other users by selecting the image of the user with which they wish to communicate.
Images, device ID#'s, and network addresses that are received for confirmation purposes self-delete within a short time (measured in seconds or minutes) if not used to send a message.
User #1 has the ability to instruct her device (Device #1) to issue an “erase” command to any other device (Device #2) at any time, as long as Device #1 has Device #2's device ID# and network address. This erase command causes the erasure of User #1's image, device ID# and network address from Device #2. But at the same time, Device #2's information is also erased from Device #1.
Users are able to deactivate participation in any of the features offered independently. For example, a user may want to maintain the capability of receiving Discreet Messages while at the same time may not want to receive regular (non-Discreet) messages.
There is no capability of exporting from a device any information about other users.
All communications between devices is encrypted with a common system-wide key to prevent non-system devices from eavesdropping. This key is periodically changed, and the new key is automatically propagated and installed from device to device, whenever devices communicate. Devices retain previous keys in order to be able to communicate with other devices that have not yet been updated. The ability to automatically install a new encryption key is guarded by a system-wide password stored in the firmware of all devices, and invoked in all legitimate encryption key updates.

Advantages of this System Over Prior Art
1. In “romantic negotiation”, this invention reduces uncertainty over whether or not there is a mutual attraction between people that have never met, as well as between people who already know each other. Other systems using the internet (SecretAdmirer.com) or cellular telephone systems (Flirtylizer) provide a means of reducing this uncertainty between people who already know each other; but it is impossible to apply those systems to people for whom no contact information is known. Using the present invention, people, whether they are strangers or not, can safely communicate their interest in each other unencumbered by issues of personal rejection. And because this invention allows a risk-free method of expressing interest in another person, it would encourage people to more freely express their interest in others.
2. If people learn to depend on Discreet Messaging to inform them if an interest they have in someone is reciprocated before they approach that person, then it will reduce the frequency of unsolicited and potentially unwanted propositions. For romantic applications it will therefore reduce the frequency of people being in the uncomfortable position of having to reject someone else who expresses romantic interest when that interest is not reciprocated. No other technology can provide this service between individuals who have never met and have no mutual contact information.
3. If a user disables regular messaging and only allows Discreet Messaging, that user has essentially prevented any possibility of receiving unsolicited messages.
4. It allows a user to conveniently send an electronic message (text, voice, image, or video) to a specific person without knowing that person's name or contact information. There is no other technology that offers this capability.
5. Perceptual Addressing gives people a socially discreet way of communicating with another person they don't know, unencumbered by the appropriateness of the social situation or specific other people who may also be present.
6. Perceptual Addressing gives one person a convenient way of communicating with an unknown person in situations in which other means of communication may not be possible such as, for example, when the other person is in another car on the road, or sitting several seats away during a lecture or performance.
7. Perceptual Addressing allows team members to communicate with each other based upon spatial position without the need to know which person is in which position, or without the need to broadcast messages. This may be useful in either military or civilian operations.

1-76. (canceled)

77. A method comprising:
receiving a first input in a first communication terminal from a first person, wherein receiving the first input is an operation in a first method of perceptual addressing, and wherein the first input specifies a second person;
presenting to the first person a first set of information as a result of a second communication terminal receiving a second input from the second person, wherein receiving the second input is an operation in a second method of perceptual addressing, wherein the second input specifies the first person, wherein the second input occurs before the first input, wherein both the second and first input occur before presenting, and wherein presenting occurs only if both the second and first input have occurred.

78. The method of claim 77, wherein the first method of perceptual addressing employs the first communication terminal and a functionally integrated camera that captures an image of the second person.

79. The method of claim 77, wherein the first method of perceptual addressing comprises detecting a physical distance, direction, or position of the second person;

80. The method of claim 77, wherein the first method of perceptual addressing employs the first communication terminal and a functionally integrated microphone that captures a voice sample of the second person.

81. The method of claim 77 further comprising receiving a distinguishing factor of the second person from a server before receiving the first input.

82. The method of claim 77 further comprising receiving a distinguishing factor of the second person from the second communication terminal before receiving the first input.

83. The method of claim 82, wherein the distinguishing factor of the second person is received in an unaddressed transmission.

84. The method of claim 77 further comprising presenting to the first person an indication of the appearance of the second person before receiving the first input.

85. The method of claim 77 further comprising presenting to the first person an indication of the voice of the second person before receiving the first input.

86. The method of claim 77 further comprising presenting to the first person an indication of the location of the second person before receiving the first input.

87. The method of claim 77 further comprising determining, before receiving the first input, a list comprised of distinguishing factors of people that are in the proximity of the first communication terminal at the time the list is determined.

88. The method of claim 77, wherein the first input results in the determination of a communication address of the second person before presenting the first set of information.

89. The method of claim 88 further comprising transmitting to the communication address of the second person before presenting.

90. The method of claim 88 further comprising transmitting to a server a distinguishing factor of the second person before presenting.

91. The method of claim 77, further comprising initiating the transmitting of a second set of information to the second communication terminal before presenting the first set of information.

92. The method of claim 91, wherein the first set of information comprises contact or identification information of the second person, and the second set of information comprises contact or identification information of the first person.

93. The method of claim 77 further comprising:
receiving the first set of information in the form of a wireless transmission before receiving the first input from the first person.

94. The method of claim 93, further comprising:
storing the first set of information at least until the presenting to the first person a first set of information.

95. The method of claim 77, wherein presenting the first set of information to the first person is the first time that any information is presented to the first person as a result of the second communication terminal receiving the second input from the second person.

96. The method of claim 77, wherein the first method of perceptual addressing and second method of perceptual addressing are the same.

97. A method of exchanging data, comprising:
specifying in a first electronic device a recipient via perceptual addressing; and
sending information from the first electronic device indicating an intent to conditionally communicate with the recipient upon an expression of interest from the recipient in communicating with a user of the first electronic device.

98. The method of claim 97, wherein perceptual addressing comprises indicating the appearance of the recipient.

99. The method of claim 97, wherein perceptual addressing comprises indicating the voice of the recipient.

100. The method of claim 97, wherein perceptual addressing comprises indicating a physical location of the recipient.

101. The method of claim 97, wherein specifying a recipient via perceptual addressing comprises sending perceptual addressing data to a server.

102. The method of claim 97, wherein specifying a recipient via perceptual addressing comprises sending perceptual addressing data to at least one other electronic device in the first electronic device's perceptual proximity.

103. The method of claim 97, wherein sending information comprises sending the information to a server.

104. The method of claim 97, wherein sending information comprises sending the information to at least one other electronic device in the first electronic device's perceptual proximity.

105. The method of claim 97, further comprising sending a conditional message from the first electronic device to the specified recipient electronic device such that the conditional message is visible to a recipient device user only upon the expression of interest from the recipient in communicating with a user of the first electronic device.

106. The method of claim 97, wherein the recipient is a user of a second electronic device within the perceptual proximity of the first electronic device.

107. A method comprising:
receiving input from a first person indicating an observable distinguishing characteristic of a second person that is in physical proximity to the first person that results in the determination of a communication address associated with the second person; then presenting to the first person for the first time a communication that was both directed to the first person, and initiated by the second person before the first person indicated the observable distinguishing characteristic of the second person.
